(19) United States
(12) Patent Application Publication
(10) Pub. No.: US 2024/0363879 A1
(43) Pub. Date: Oct. 31, 2024

(54) NOVEL ALIPHATIC CHAIN-CONTAINING POLY(ALKYL-ARYL PIPERIDINIUM) POLYMER IONOMER, ANION EXCHANGE MEMBRANE, COMPOSITE MEMBRANE, AND MANUFACTURING METHOD THEREFOR

(71) Applicant: IUCF-HYU (INDUSTRY-UNIVERSITY COOPERATION FOUNDATION HANYANG UNIVERSITY), Seoul (KR)

(72) Inventors: Young Moo LEE, Seoul (KR); Jong Hyeong PARK, Seoul (KR); Chuan HU, Seoul (KR); Nanjun CHEN, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/287,841

(22) PCT Filed: Apr. 22, 2022
(86) PCT No.: PCT/KR2022/005755

§ 371 Date: Oct. 20, 2023

(30) Foreign Application Priority Data
Apr. 22, 2021 (KR) 10-2021-0052052
Jan. 24, 2022 (KR) 10-2022-0009882

(51) Int. Cl. H01M 8/103; B01J 41/05; B01J 41/13; B01J 47/12; C08G 61/12; C08J 5/22; C25B 13/08; H01M 8/083; H01M 8/10; H01M 8/1004

(52) U.S. Cl. CPC H01M 8/103; B01J 41/05; B01J 41/13; B01J 47/12; C08G 61/122; C08J 5/2256; C25B 13/08; H01M 8/083; H01M 8/1004; C08G 2261/124; C08G 2261/312; C08G 2261/334; C08G 2261/40; C08G 2261/72; C08G 2261/90; C08J 2365/00; H01M 2008/1095

(57) ABSTRACT

The present disclosure relates to the synthesis of a poly (alkyl-co-aryl piperidinium) polymer, which has no aryl-ether bond in the polymer backbone, contains an aliphatic chain in a repeating unit and has a piperidinium group introduced therein, and to the preparation of an anion exchange membrane and a composite membrane using the same. The anion exchange membrane and the composite membrane according to the present disclosure have superior alkaline stability and mechanical properties and very high ion conductivity. Furthermore, they reduce the phenyl adsorption effect of an electrode catalyst and exhibit high water permeability and power density as well as excellent durability. Thus, they can be applied to membranes and binders for alkaline fuel cells or water electrolysis.

### TECHNICAL FIELD

The present disclosure relates to a novel aliphatic chain-containing poly (alkyl-aryl piperidinium) polymer ionomer, an anion exchange membrane, a composite membrane and a method for preparing the same, more particularly to the synthesis of a poly (alkyl-aryl piperidinium) polymer, which has no aryl-ether bond in the polymer backbone, contains an aliphatic chain in a repeating unit and has a piperidinium group introduced therein, and to the preparation of an anion exchange membrane and a composite membrane using the same for application to an alkaline fuel cell and a water electrolysis device.

### BACKGROUND ART

So far, many researches have been conducted on polymer electrolyte membrane fuel cells (PEMFCs) due to their relatively high current density and environmental friendliness. In particular, perfluorocarbon-based proton exchange membranes represented by Nafion have been mainly used as polymer electrolyte membranes. Although Nafion membranes have superior chemical stability and high ion conductivity, they are very expensive and have low glass transition temperatures. Therefore, researches are being carried out actively on alternatives to Nafion such as aromatic hydrocarbon-based polymer electrolyte membranes, etc.

Among them, alkaline membrane fuel cells (AMFCs) using anion exchange membranes have attracted attention recently. In particular, the alkaline membrane fuel cells are being researched consistently since inexpensive non-precious metal electrode catalysts such as nickel, manganese, etc. instead of platinum can be used and they exhibit superior performance as well as significantly high price competitiveness as compared to polymer electrolyte membrane fuel cells.

For anion exchange membranes for use in alkaline membrane fuel cells, the synthesis method of introducing benzyltrimethylammonium groups into aryl ether-based aromatic polymer structures such as polysulfone (PSF), polyphenyl ether (PPO), polyether ether ketone (PEEK), etc. is known. This method is advantages in that the solubility, etc. of the polymer is improved as repeating units having aryl-ether (C—O) bonds are formed along the polymer main chain. However, on the other hand, the aryl-ether bonds of the polymer main chain lead to the degradation of hydroxyl radicals of the electrolyte membranes during the operation of the fuel cells, thereby resulting in a worsening of long-term stability. Therefore, it is necessary to prevent the degradation of the polymer main chain to improve the durability of the alkaline membrane fuel cells.

In addition, since the conventional anion exchange membranes have limited chemical stability (less than 500 hours in 1 M NaOH solution at 80° C.) and mechanical properties (tensile strength lower than 30 MPa), the fuel cells using them have low power density (0.1-0.5 W cm⁻²) and durability. In addition, the conventional anion exchange ionomers with high phenyl contents have the problem that hydrogen oxidation reaction (HOR) and oxygen reduction reaction (ORR) in the anion exchange fuel cells are significantly limited due to the high adsorption of the phenyl structures on the electrode catalyst surface. In addition, since typical anion exchange ionomers have poor ability of effectively transferring the water generated at the anode of the anion fuel cell to the cathode due to low water permeability, there are problems that power density is low and alkaline stability is decreased during the operation of the alkaline fuel cell.

The preparation of aromatic polymers without aryl-ether bonds for solving the chemical stability problem when using the anion exchange membranes in alkaline membrane fuel cells has been known. Polymer electrolytes provide desirable characteristics to the aromatic polymer backbone such as high glass transition temperature, impact strength, toughness, thermal/chemical/mechanical stability, low moisture content compared to polyolefin-based electrolytes, etc. In addition to the alkali-stable aromatic polymer backbone structure, the stability of the cations introduced into the aromatic polymer contributes to its long-term durability. The introduced cations include tetraalkylammonium, benzyltrimethylammonium, piperidinium, etc.

However, a poly (alkyl-co-aryl piperidinium) polymer, which has no aryl-ether bond in the polymer backbone, contains an aliphatic chain in a repeating unit and has a piperidinium group introduced therein, has not been synthesized yet and nothing is specifically known about its application to a membrane or a binder for alkaline fuel cells or water electrolysis.

The inventors of the present disclosure have conducted researches to expand the application of aromatic polymer ion exchange membranes having superior thermal/chemical stability and mechanical properties. As a result, they have prepared a poly (alkyl-co-aryl piperidinium) polymer, which has no aryl-ether bond in the polymer backbone, contains an aliphatic chain in a repeating unit and has a piperidinium group introduced therein, prepared an anion exchange membrane and a composite membrane thereof from the same and found out that they can be applied to a membrane or a binder for alkaline fuel cells or water electrolysis.

### REFERENCES OF RELATED ART

### Patent Documents

Patent document 1: Korean Patent Publication No. 10-2018-0121961.
Patent document 2: International Patent Publication No. WO 2019/068051.
Patent document 3: Chinese Patent Publication No. CN 109384908.
Patent document 4: US Patent Publication No. US 2019/0036143.

### DISCLOSURE

### Technical Problem

The present disclosure is directed to providing a novel aliphatic chain-containing poly (alkyl-co-aryl piperidinium) polymer as ionomer, which has superior alkaline stability and mechanical properties and high ion conductivity, reduces the phenyl adsorption effect of an electrode catalyst and has high water permeability, and a method for preparing the same.

In addition, the present disclosure is directed to preparing an anion exchange membrane or a composite membrane thereof from the novel aliphatic chain-containing poly (alkyl-co-aryl piperidinium) polymer for application to a membrane or a binder for alkaline fuel cells or water electrolysis devices.

### Technical Solution

The present disclosure provides a poly (alkyl-co-aryl piperidinium) polymer having a repeating unit represented by any one selected from <Chemical Formula 1> to <Chemical Formula 3>:

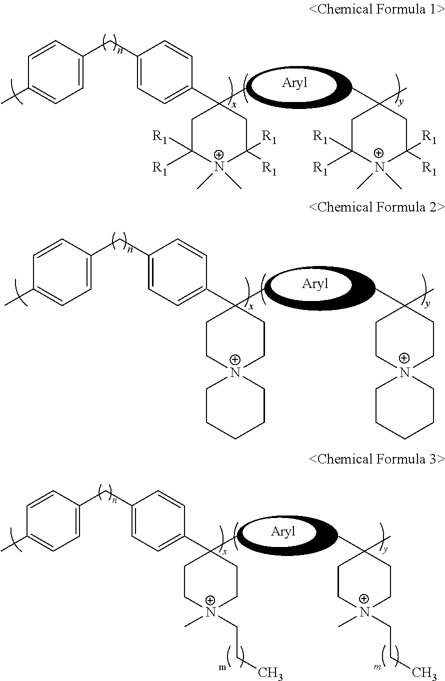

wherein Aryl is any one selected from the following structural formulas:

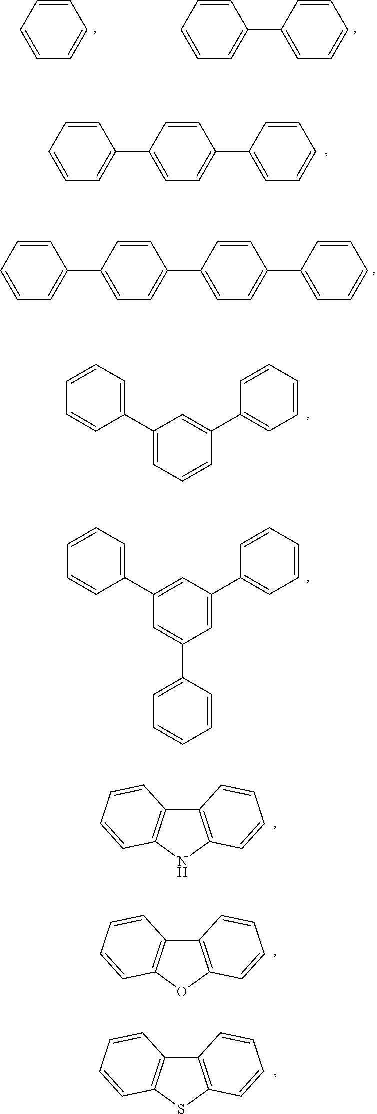

wherein n and m are integers from 1 to 10 and x and y are mole fractions (%) of polymer ionomers in the repeating unit, satisfying x>0, y>0 and x+y=100.

In addition, the present disclosure provides a method for preparing a poly (alkyl-co-aryl piperidinium) polymer ionomer, which includes:
(I) a step of forming a solution by dissolving a diphenylalkane, 1-methyl-4-piperidone and compounds represented by the following structural formulas as monomers in an organic solvent:

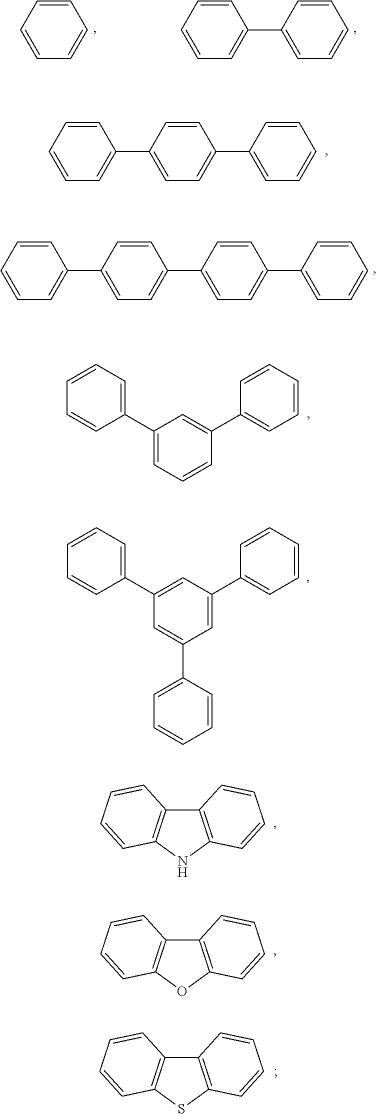

(II) a step of obtaining a viscous solution by slowly adding a strong acid catalyst to the solution and conducting stirring and reaction; (III) a step of obtaining a polymer in solid phase by precipitating, washing and drying the viscous solution; (IV) a step of forming a quaternary piperidinium salt by adding K₂CO₃ and an excess halomethane to a polymer solution obtained by dissolving the polymer in solid phase in an organic solvent and conducting reaction; and (V) a step of precipitating, washing and drying the polymer powders.

In addition, the present disclosure provides an anion exchange membrane containing the poly (alkyl-co-aryl piperidinium) polymer as ionomer.

In addition, the present disclosure provides an anion exchange composite membrane including: a porous polymer support; and the anion exchange membrane which is impregnated in the porous polymer support.

In addition, the present disclosure provides a method for preparing an anion exchange membrane, which includes: (a) a step of forming a polymer solution by dissolving the poly (alkyl-co-aryl piperidinium) polymer ionomer in an organic solvent; (b) a step of obtaining a membrane by casting the polymer solution on a glass plate and drying the same; and (c) a step of treating the membrane with 1 M NaHCO₃ or 1 M NaOH, washing the same several times with ultrapure water and then drying the same.

In addition, the present disclosure provides a method for preparing an anion exchange composite membrane, which includes: (i) a step of preparing a porous polymer support; (ii) a step of obtaining an ionomer solution by adding a cosolvent to a polymer solution prepared by dissolving the poly (alkyl-co-aryl piperidinium) polymer in an organic solvent; and (iii) a step of casting the ionomer solution on the porous polymer support and then impregnating and drying the same.

In addition, the present disclosure provides a binder for an alkaline fuel cell, which contains the poly (alkyl-co-aryl piperidinium) polymer.

In addition, the present disclosure provides a membrane electrode assembly for an alkaline fuel cell, which includes the anion exchange membrane or the anion exchange composite membrane.

In addition, the present disclosure provides an alkaline fuel cell including the anion exchange membrane or the anion exchange composite membrane.

In addition, the present disclosure provides a water electrolysis device including the anion exchange membrane or the anion exchange composite membrane.

### Advantageous Effects

An anion exchange membrane and a composite membrane thereof prepared from a novel poly (alkyl-co-aryl piperidinium) polymer ionomer according to the present disclosure have superior alkaline stability and mechanical properties and very high ion conductivity. In addition, since they reduce the phenyl adsorption effect of an electrode catalyst and exhibit high water permeability and power density and excellent durability, they can be applied to a membrane or a binder for alkaline fuel cells or water electrolysis.

### BRIEF DESCRIPTION OF DRAWINGS

FIG. 1 shows the nuclear magnetic resonance (¹H NMR) spectrum of PDTP-25 prepared in Example 1 (10% TFA was added as a cosolvent to DMSO-de in order to remove the effect of water at 3.34 ppm).

FIG. 2 shows the nuclear magnetic resonance (¹H NMR) spectrum of PDTP-50 prepared in Example 2 (10% TFA was added as a cosolvent to DMSO-de in order to remove the effect of water at 3.34 ppm).

FIG. 3 shows the nuclear magnetic resonance (¹H NMR) spectrum of PDTP-75 prepared in Example 3 (10% TFA was added as a cosolvent to DMSO-de in order to remove the effect of water at 3.34 ppm).

FIG. 4A shows a schematic diagram of a membrane electrode assembly (MEA) with three-phase boundaries, FIG. 4B shows the hydrogen permeability of a PDTP-25 membrane, a PDTP-50 membrane and a PDTP-75 membrane prepared in Example 4, a PTP membrane prepared in Comparative Example 2 and a commercial FAA-3 membrane as a control group depending on relative humidity (in I⁻ form at 60° C.), FIG. 4C shows the water vapor permeability of a PDTP-25 membrane, a PDTP-50 membrane and a PDTP-75 membrane prepared in Example 4, a commercial FAA-3 membrane as a control group and a PFBP membrane filed previously by the inventors of the present disclosure (Korean Patent Application No. 10-2020-0093640) depending on relative humidity (in I⁻ form at 60° C.) and FIG. 4D shows the hydroxide ion conductivity of a PDTP-25 membrane, a PDTP-50 membrane and a PDTP-75 membrane prepared in Example 4 and a PTP membrane prepared in Comparative Example 2 depending on relative humidity (in OH⁻ form at 60° C.).

FIG. 5A shows the mechanical properties of a PDTP-25 membrane, a PDTP-50 membrane and a PDTP-75 membrane prepared in Example 4, a PTP membrane prepared in Comparative Example 2 (in I⁻ form) and a commercial FAA-3-20 membrane as a control group (in Cl⁻ form) at wet state, FIG. 5B shows the photographic image of a transparent and strong PDTP-25 membrane (thickness: 25 μm) and FIGS. 5C to 5F show the storage modulus and tan δ of the membranes [(c) PTP membrane, (d) PDTP-25 membrane, (e) PDTP-50 membrane and (f) PDTP-75 membrane (in I⁻ form)].

FIGS. 6A to 6G show the atomic force microscopy (AFM) images of (FIG. 6A) a PTP membrane prepared in Comparative Example 2 and (FIG. 6B) a PDTP-25 membrane, (FIG. 6C) a PDTP-50 membrane and (FIG. 6D) a PDTP-75 membrane prepared in Example 4 (in I⁻ form), (FIG. 6E) the cross-sectional scanning electron microscopy (SEM) image of the PDTP-25 membrane and the photographs of (FIG. 6F) PDTP-75 and PFBP ionomer solutions (in isopropyl alcohol:deionized water=10:1) and (FIG. 6G) a PDTP-based membrane electrode assembly (MEA).

FIG. 7A shows the DVS data [25° C., different relative humidities (0%, 18%, 36%, 54%, 72% and 90%)] and Arrhenius plots based on (FIG. 7B) OH-conductivity, (FIG. 7C) HCO₃⁻ conductivity and (FIG. 7D) OH-conductivity of a PDTP-25 membrane, a PDTP-50 membrane and a PDTP-75 membrane prepared in Example 4 and a PTP membrane prepared in Comparative Example 2.

FIG. 8 shows the thermogravimetric analysis (TGA) and derivative curves of a PDTP-25 membrane, a PDTP-50 membrane and a PDTP-75 membrane prepared in Example 4 and a PTP membrane prepared in Comparative Example 2.

FIG. 9 shows the performance of anion exchange membrane fuel cells (AEMFCs) having various anode/cathode ionomers based on a PDTP-25 membrane (thickness: 25±3 μm) [80° C., 1,000/1,000 anode/cathode H₂/O₂ flow rate, various anode/cathode catalysts (ionomer:total carbon:metal=1:2:1.33, Hipsec Pt/C-based slurry, 1:1.78:1.55, TKK Pt/C-based slurry, and 1:1.33:2, PtRu/C-based slurry)]. a) anode/cathode 0.26 mg cm⁻² TKK Pt/C, 0/0 bar anode/cathode back pressure, b), anode/cathode 0.26 mg cm⁻² TKK Pt/C, 0/0 bar anode/cathode back pressure. 2.0/2.0 bar anode/cathode back pressure, c) anode/cathode PFBP/PDTP-75 ionomers, 0/0 anode/cathode back pressure, three types of anode/cathode catalysts with 0.26 mg cm⁻² loading: Pt—Ru/C anode and Hispect Pt/C cathode, anode/cathode Hispec Pt/C anode, and anode/cathode TKK Pt/C, d) anode/cathode PFBP/PDTP-75 ionomers, 2.0/2.0 bar anode/cathode back pressure, three types of anode/cathode catalysts with 0.26 mg cm⁻² loading: Pt—Ru/C anode and Hispect Pt/C cathode, anode/cathode Hispec Pt/C anode, and A/C TKK Pt/C.

FIG. 10 shows a) the performance of anion exchange membrane fuel cells (AEMFCs) based on a PDTP-25 membrane (thickness: 22±3 μm) and various cathode/anode ionomers [testing conditions: 0.39 mg cm⁻² Pt—Ru/C in the anode along with carbon powder (ionomer:total carbon:Pt—Ru=1:2.33:2), 0.26 mg cm⁻² Hispec Pt/C in the cathode (ionomer:total carbon:metal=1:2:1.33), 1,000/1,000 mL min⁻¹ H₂—O₂ flow rate, 1,000/2,000 mL min⁻¹ H₂-air (CO₂ free) flow rate, 1.3/1.3 bar back pressure] and b) the comparison of specific power and power density of a previously known AEMFC and a commercial AEMFC (anode/cathode PGM catalysts).

FIG. 11 shows the nuclear magnetic resonance (¹H NMR) spectra of a PDTP-25 membrane prepared in Example 4 depending on time in a 1 M NaOH solution at 80° C. (No degradation of piperidinium groups was detected).

FIG. 12 shows (a) the in-situ durability of a fuel cell using a PDTP-25 membrane prepared in Example 4 (80° C., 200/200 mL min⁻¹ flow rate, 0.33 mg cm⁻² loading of Hispec Pt/C, 0.4 A cm⁻² current density) and the -situ durability of a fuel cell using a commercial FAA-3-20 membrane (60° C., 200/200 mL min⁻¹ flow rate, 0.33 mg cm⁻² loading of Hispec Pt/C, 0.2 A cm⁻² current density) and (b) the nuclear magnetic resonance (¹H NMR) spectra of the PDTP-25 membrane and PFBP/PDTP-25 ionomers disassembled from the membrane electrode assembly (MEA) before and after the in-situ durability for 100 hours.

FIG. 13A shows the photographic image of an anion exchange composite membrane prepared in Example 5 and FIG. 13B to 13D show the scanning electron microscopy (SEM) images showing its morphology.

FIGS. 14A and 14B show the UV transmittance of PDTP-25 membranes in an anion exchange composite membrane prepared in Example 5 and an anion exchange membrane prepared in Example 4 (PDTP) as a measure of transparency [(FIG. 14A) I⁻ form, (FIG. 14B) OH⁻ form].

FIG. 15 shows the mechanical properties of PDTP-25 membranes in an anion exchange composite membrane prepared in Example 5 and an anion exchange membrane prepared in Example 4 (PDTP) and a porous polyethylene support as a control group.

FIGS. 16A to 16C show the dimensional stability of PDTP-25 membranes in an anion exchange composite membrane prepared in Example 5 and an anion exchange membrane prepared in Example 4 (PDTP).

FIG. 17A shows the hydrogen permeability and FIG. 17B shows water permeability of PDTP-25 membranes in an anion exchange composite membrane prepared in Example 5 and an anion exchange membrane prepared in Example 4 (PDTP) and a commercial anion exchange membrane (FAA-3-50) as a control group.

FIG. 18A shows the current density of PDTP-25 membranes in an anion exchange composite membrane prepared in Example 5 and an anion exchange membrane prepared in Example 4 (PDTP) depending on relative humidity and FIG. 18B shows the current density of an anion exchange composite membrane with time depending on the relative humidity of a feed gas.

FIG. 19 shows the change in the current density of PDTP-25 membranes in an anion exchange composite membrane prepared in Example 5 and an anion exchange membrane prepared in Example 4 (PDTP) with time.

FIGS. 20A to 20C show the fuel cell performance of PDTP-25 membranes in an anion exchange composite membrane prepared in Example 5 and an anion exchange membrane prepared in Example 4 (PDTP).

FIG. 21 shows a result of evaluating the long-term lifetime of PDTP-25 membranes in an anion exchange composite membrane prepared in Example 5 and an anion exchange membrane prepared in Example 4 (PDTP).

FIG. 22 shows the change in the mechanical strength of PDTP-25 membranes in an anion exchange composite membrane prepared in Example 5 and an anion exchange membrane prepared in Example 4 (PDTP) before and after evaluation of long-term lifetime.

FIG. 23 shows the nuclear magnetic resonance (¹HNMR) spectra of an anion exchange composite membrane prepared in Example 5 before and after evaluation of long-term lifetime.

### BEST MODE

Hereinafter, a novel aliphatic chain-containing poly (alkyl-co-aryl piperidinium) polymer ionomer, an anion exchange membrane and a method for preparing the same according to the present disclosure will be described in detail.

The present disclosure provides a poly (alkyl-co-aryl piperidinium) polymer ionomer containing a repeating unit represented by any of <Chemical Formula 1> to <Chemical Formula 3>.

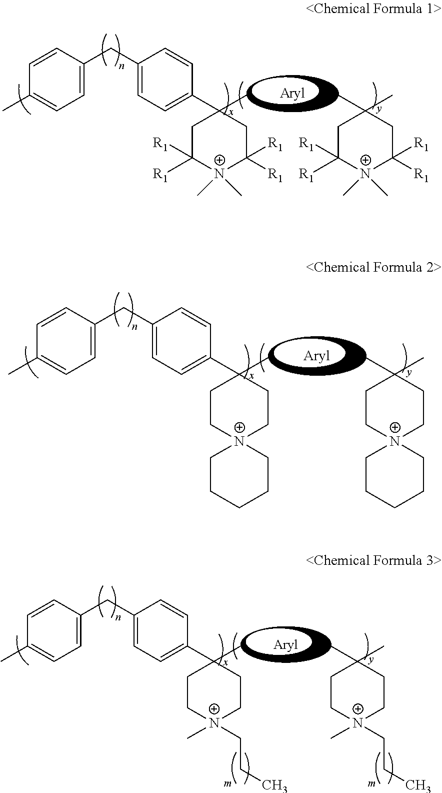

In Chemical Formulas 1-3, Aryl is any one selected from the compound represented by the following structural formulas:

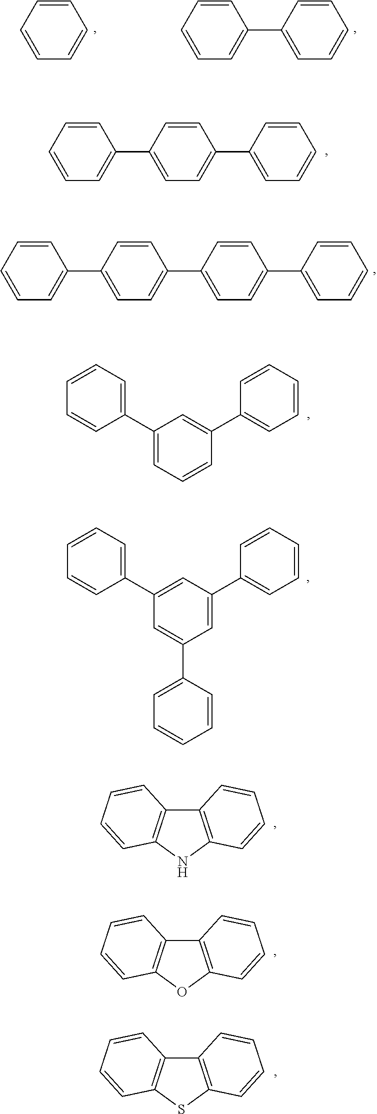

and
n and m are integers from 1 to 10 and x and y are mole fractions (%) of polymer ionomers in the repeating unit, satisfying x>0, y>0 and x+y=100.

As shown in Chemical Formulas 1-3, in the present disclosure, since the novel aliphatic chain-containing poly (alkyl-co-aryl piperidinium) polymer ionomer contains an aliphatic chain and a piperidinium group exhibiting high chemical stability, it can significantly improve film-forming ability and mechanical properties.

In Chemical Formulas 1-3, n may be integers from 1 to 10. That is to say, diphenyl may be connected by a C₁₋₁₀ alkylene. That is to say, the repeating unit may be specifically diphenylmethane or diphenylethane with n being 1 or 2 or diphenylhexane to diphenyldecane with n being 6 to 10. More specifically, it may be a diphenylethane unit with n being 2.

In addition, the Aryl may be selected from aryls such as phenyl, biphenyl, terphenyl, quaterphenyl, etc. or heteroaryls such as carbazole, dibenzofuran, dibenzothiophene, etc. as defined in Chemical Formulas 1-3.

In particular, the aliphatic chain structure of the poly (alkyl-co-aryl piperidinium) polymer ionomer defined in Chemical Formulas 1-3 can effectively reduce the phenyl adsorption effect of an electrode catalyst by lowering the phenyl content of an anion exchange binder. In addition, with high water permeability, it can enhance the diffusion of water to deal with the issue of water content control. Furthermore, it exhibits superior solubility even in solvents having low boiling points (e.g., isopropyl alcohol/distilled water) and shows low adsorption effect for catalysts. In addition, the aliphatic chain structures of Chemical Formulas 1-3 show increased water absorption (water uptake) and swelling (swelling ratio) and are expected to exhibit improved water back diffusion during the operation of a fuel cell as the number of carbon atoms is increased.

Furthermore, since it is stable and exhibits superior ion conductivity with a high ion exchange capability (IEC) even in alkaline media due to the introduction of the piperidinium group in the repeating unit with no aryl-ether bond in the polymer backbone, it can improve the ability of water diffusion and water content control in anion exchange fuel cells, water electrolysis, etc.

In addition, the present disclosure provides a method for preparing a poly (alkyl-co-aryl piperidinium) polymer, which includes:
(I) a step of forming a solution by dissolving a diphenylalkane, 1-methyl-4-piperidone and compounds represented by the following structural formulas as monomers in an organic solvent:

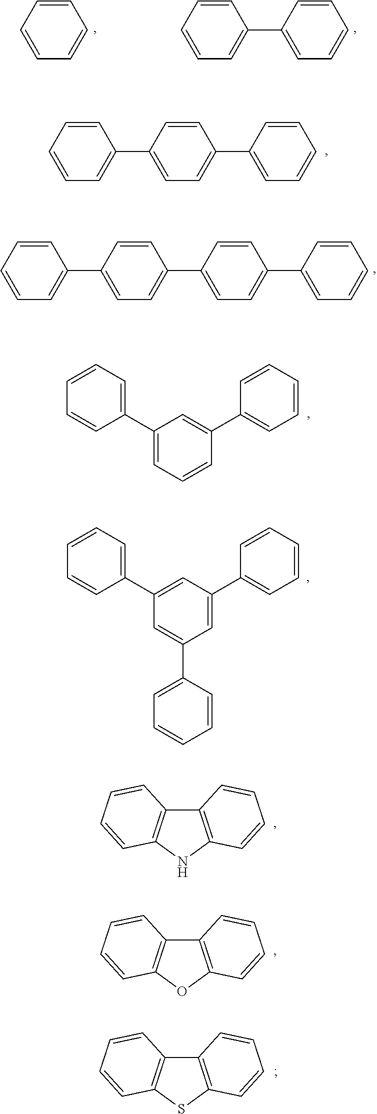

(II) a step of obtaining a viscous solution by slowly adding a strong acid catalyst to the solution and conducting stirring and reaction; (III) a step of obtaining a polymer in solid phase by precipitating, washing and drying the viscous solution; (IV) a step of forming a quaternary piperidinium salt by adding K₂CO₃ and an excess halomethane to a polymer solution obtained by dissolving the polymer in solid phase in an organic solvent and conducting reaction; and (V) a step of precipitating, washing and drying the polymer solution.

First, in order to prepare a poly (alkyl-co-aryl piperidine)-based polymer, a diphenylalkane, 1-methyl-4-piperidone and the compounds represented by the above structural formulas are reacted as monomers. In the diphenylalkane, the alkane may be specifically diphenylmethane or diphenylethane with 1 or 2 carbon atoms or diphenylhexane to diphenyldecane with 6 to 10 carbon atoms. More specifically, it may be diphenylethane.

Then, the desired poly (alkyl-co-aryl piperidinium) polymer ionomer with in the form of a quaternary piperidinium salt may be prepared by reacting the poly (alkyl-co-aryl piperidine)-based polymer including a diphenylalkane segment containing an aliphatic chain structure and various aryl segments represented by the above structural formulas with a halomethane.

The organic solvent in the step (I) may be one or more halogen-based solvent selected from dichloromethane, chloroform, dichloroethane, dibromomethane and tetrachloroethane, specifically dichloromethane.

In addition, the strong acid catalyst in the step (II) may be trifluoroacetic acid, trifluoromethanesulfonic acid, pentafluoroethanesulfonic acid, heptafluoro-1-propanesulfonic acid, perfluoropropionic acid, heptafluorobutyric acid or a mixture thereof, specifically a mixture of trifluoroacetic acid and trifluoromethanesulfonic acid. In addition, the organic solvent in the step (IV) may be N-methylpyrrolidone, dimethylacetamide, dimethyl sulfoxide or dimethylformamide.

In addition, in the step (IV), the polymer is reacted with a halomethane to form a quaternary piperidinium salt. The halomethane may be fluoromethane, chloromethane, bromomethane or iodomethane, specifically iodomethane.

In addition, the present disclosure provides an anion exchange membrane containing the poly (alkyl-co-aryl piperidinium) polymer.

In addition, the present disclosure provides an anion exchange composite membrane including: a porous polymer support; and the anion exchange membrane prepared above, impregnated in the porous polymer support.

The porous polymer support may be selected from a group consisting of polyethylene, polypropylene, polytetrafluoroethylene, polyvinylidene fluoride, polyhexafluoropropylene and poly (perfluoroalkyl vinyl ether), although not being limited thereto.

More specifically, the porous polymer support may have a pore size of 0.01-0.5 μm and a porosity of 50-90% so that the poly (alkyl-co-aryl piperidinium) polymer ionomer solution can be impregnated stably.

Although the porous polymer support is mostly hydrophobic, the surface of the porous polymer support may be fluorinated or hydrophilized to improve the affinity between the porous polymer support and the poly (alkyl-aryl piperidinium) polymer and form a defect-free anion exchange membrane by stably impregnating the polymer ionomer solution.

Specifically, the fluorination is performed by immersing the porous polymer support in an ethanol solution, conducting ultrasonic dispersion at −10 to 25° C. and then drying the porous polymer support at room temperature. Subsequently, the dried porous polymer support is put in a vacuum chamber and an inert atmosphere is created inside the chamber by purging with nitrogen gas. Then, a fluorinated porous polymer support is obtained by directly fluorinating the surface for 5-60 minutes at room temperature by supplying fluorine gas (500±15 ppm F₂/N₂ at atmospheric pressure) at a rate of 1 L/min into the vacuum chamber and the residual fluorine gas is removed using nitrogen gas with a scrubber filled with activated carbon.

And, the hydrophilization may be performed by coating the surface of the porous polymer support with a C₁₋₃ hydrophilic alkyl alcohol, dopamine or a hydrophilic polymer such as polyvinyl alcohol.

In addition, the present disclosure provides a method for preparing an anion exchange membrane, which includes: (a) a step of forming a polymer solution by dissolving the poly (alkyl-co-aryl piperidinium) polymer ionomer in an organic solvent; (b) a step of obtaining a membrane by casting the polymer solution on a glass plate and drying the same; and (c) a step of treating the membrane with 1 M NaHCO₃ or 1 M NaOH, washing the same several times with ultrapure water and then drying the same.

The organic solvent in the step (a) may be N-methylpyrrolidone, dimethylacetamide, dimethyl sulfoxide or dimethylformamide.

In addition, the concentration of the polymer solution may be 2-30 wt %, specifically 10˜30 wt %, more specifically 20-27%. If the concentration of the polymer solution is below 2 wt %, the film-forming ability of the membrane may be unsatisfactory. And, if it exceeds 30 wt %, the physical properties of the membrane may be unsatisfactory because of too high viscosity.

In addition, the drying in the step (b) may be specifically performed by slowly removing the organic solvent in an oven at 80-90° C. for 24 hours and then completely removing the organic solvent by heating for 12 hours in a vacuum oven at 120-150° C. If the polymer solution in the step (b) is of high concentration, the membrane may be obtained by heating in an oven at 100° C. for 30 minutes or shorter.

Then, the poly (alkyl-co-aryl piperidinium) polymer membrane obtained through the steps (a) and (b) may be treated with 1 M NaHCO₃ or 1 M NaOH to prepare an anion exchange membrane in which the halide (I⁻, etc.) of the poly (alkyl-co-aryl piperidinium) polymer ionomer has been converted to HCO₃⁻ or OH⁻.

In addition, the present disclosure provides a method for preparing an anion exchange composite membrane, which includes: (i) a step of preparing a porous polymer support; (ii) a step of obtaining an ionomer solution by adding a cosolvent to a polymer solution prepared by dissolving the poly (alkyl-co-aryl piperidinium) polymer in an organic solvent; and (iii) a step of casting the ionomer solution on the porous polymer support and then impregnating and drying the same.

The surface of the porous polymer support in the step (i) may be fluorinated or hydrophilized by the methods described above.

In addition, the organic solvent in the step (ii) may be N-methylpyrrolidone, dimethylacetamide, dimethyl sulfoxide or dimethylformamide, specifically dimethyl sulfoxide.

In the present disclosure, unlike the prior art, a polymer solution is obtained by adding a cosolvent to a polymer solution prepared by dissolving the poly (alkyl-co-aryl piperidinium) polymer ionomer in an organic solvent in order to improve the degree of impregnation of the ionomer polymer solution in the porous polymer support during the preparation of the composite membrane. This can be said to be the key technical feature of the method for preparing an anion exchange composite membrane according to the present disclosure. Since a composite membrane can be obtained by a simple method of casting a polymer solution on a porous polymer support, the membrane can be produced in large scale using a high-concentration solution.

The cosolvent is selected based on the interfacial tension with the porous polymer support determined by measuring contact angle. Methanol, ethanol or isopropyl alcohol may be used as the cosolvent. More specifically, ethanol may be used.

Specifically, the amount of the cosolvent added in the step (ii) may be 2-25 wt % based on the polymer solution. If the amount of the added cosolvent is less than 2 wt % based on the polymer solution, the ionomer polymer solution may not be easily impregnated into the porous polymer support. And, if the amount exceeds 25 wt %, it may be difficult to obtain a high-concentration polymer solution.

In addition, the present disclosure provides a binder for an alkaline fuel cell, which contains the poly (alkyl-co-aryl piperidinium) polymer.

In addition, the present disclosure provides a membrane electrode assembly for an alkaline fuel cell, which includes the anion exchange membrane or the anion exchange composite membrane.

In addition, the present disclosure provides an alkaline fuel cell including the anion exchange membrane or the anion exchange composite membrane.

In addition, the present disclosure provides a water electrolysis device including the anion exchange membrane or the anion exchange composite membrane.

Hereinafter, the present disclosure will be described specifically with examples and comparative examples referring to the attached drawings.

### [Example 1] Preparation of Poly (Alkyl-Aryl Piperidinium) Polymer Ionomer (PDTP-25)

After adding diphenylethane (1.0252 g, 5.625 mmol), terphenyl (3.885 g, 16.875 mmol) and 1-methyl-4-piperidone (2.8005 g, 24.750 mmol) into a 100-mL reactor as monomers, a solution was formed by dissolving the monomers through stirring while adding dichloromethane (18 mL). After cooling the solution to 1° C., a viscous solution was obtained by slowly adding a mixture of trifluoroacetic acid (2.7 mL) and trifluoromethanesulfonic acid (18 mL) to the solution and conducting reaction for 12 hours under stirring. The viscous solution was poured into 500 mL of distilled water, precipitated, washed several times with deionized water and dried in an oven at 70° C. for 24 hours to prepare a poly (diphenyl-co-terphenyl N-methyl piperidine) polymer in solid phase (yield: 95.3%), which was named PDTM-25.

Next, after obtaining a polymer solution by dissolving the prepared PDTM-25 (6.0 g, 12.9 mmol) in dimethyl sulfoxide (100 mL), K₂CO₃ (3.6 g, 25.8 mmol) and iodomethane (5.5 g, 38.7 mmol) were added to the polymer solution and a quaternary piperidinium salt was formed by conducting reaction at room temperature in the dark for 24 hours. Subsequently, the polymer solution was precipitated in 800 mL of ethyl acetate, filtered, washed several times with deionized water and dried in a vacuum oven at 70° C. for 24 hours to prepare a poly (diphenyl-co-terphenyl dimethyl piperidinium) polymer ionomer in solid phase (yield: 88%), which was named PDTP-25.

### [Example 2] Preparation of Poly (Alkyl-Aryl Piperidinium) Polymer Ionomer (PDTP-50)

A poly (diphenyl-co-terphenyl dimethyl piperidinium) polymer was prepared in the same manner as in Example 1 except that the monomers diphenylethane and terphenyl were used at a mole fraction of 50:50. The polymer was named PDTP-50.

### [Example 3] Preparation of Poly (Alkyl-Aryl Piperidinium) Polymer Ionomer (PDTP-75)

A poly (diphenyl-co-terphenyl dimethyl piperidinium) polymer was prepared in the same manner as in Example 1 except that the monomers diphenylethane and terphenyl were used at a mole fraction of 25:75. The polymer was named PDTP-75.

### [Example 4] Preparation of Anion Exchange Membrane from Poly (Alkyl-Aryl Piperidinium) Polymer Ionomer

A 4 wt % polymer solution was formed by dissolving the PDTP-25, PDTP-50 or PDTP-75 (1.25 g) prepared in Examples 1-3 in dimethyl sulfoxide. Then, the polymer solution was filtered through a 0.45-μm PTFE filter and the clear solution was cast on a 13×22 cm glass plate. After slowly removing the solvent by drying the casting solution in an oven at 90° C. for 24 hours, a PDTP-25 membrane, a PDTP-50 membrane or a PDTP-75 membrane (in I⁻ form, thickness 25±5 μm) was prepared by completely removing the solvent by heating in a vacuum oven at 140° C. for 12 hours.

The obtained PDTP-25 membrane, PDTP-50 membrane or PDTP-75 membrane in I⁻ form was immersed in 1 M NaHCO₃ aqueous solution or 1 M NaOH aqueous solution (at room temperature for 24 hours) for conversion to HCO₃⁻ and OH⁻ and an anion exchange membrane was prepared by washing several times with ultrapure water and then drying the same.

### [Example 5] Preparation of Anion Exchange Composite Membrane

A porous polyethylene support (W-PE) was prepared (purchased from W-Scope, thickness: 10 μm or 20 μm). An ionomer solution was obtained by adding 3.3 wt % of ethanol as a cosolvent to 10 wt % polymer solution in which the PDTP-25 obtained in Example 1 was dissolved in dimethyl sulfoxide. After fixing the porous polyethylene support (which may also be fluorinated or hydrophilized by the method described above) on a glass plate, the ionomer solution was impregnated on the support and then spread uniformly with a syringe. Then, an anion exchange composite membrane was prepared by drying in an oven at 100° C. for 1 hour and then drying again in a vacuum oven at 80° C. for 24 hours (PDTP@W-PE).

### [Comparative Example 1] Preparation of Polymer Ionomer (PTP) with No 20)

A poly (terphenyl dimethylpiperidinium) polymer ionomer was prepared in the same manner as in Example 1 by using only terphenyl and 1-methyl-4-piperidone (diphenylethane was not used) as monomers. The ionomer was named as PTP.

### [Comparative Example 2] Preparation of Anion Exchange Membrane from Polymer with No Aliphatic Chain Structure

An anion exchange membrane (PTP membrane) was prepared in the same manner as in Example 4 using the PTP polymer ionomer prepared in Comparative Example 1.

### [Instrumental Analysis and Measurement Methods]

### 1. Nuclear Magnetic Resonance Analysis (¹H NMR)

The chemical structure of the polymer ionomer was analyzed by ¹H NMR (VNMRS 600 MHZ, Varian, CA, USA). de-DMSO was used as a solvent for all the ionomers (standard chemical shift: 2.5 ppm). 10% TFA was added to all the NMR samples to eliminate the overlap effect of water (3.34 ppm). The chemical shift was >12 ppm.

### 2. Ion Exchange Capability (IEC)

The ion exchange capability (IEC) value of the anion exchange membrane was measured by Mohr titration. Briefly, the membrane sample in Br form was dried in an oven at 80° C. for 24 hours to remove residual water and solvent and the dry weight (M_{dry}) was recorded. Then, the membrane sample immersed in 0.2 M NaNO₃ at 50° C. for 48 hours to completely exchange Br. After that, the solution was titrated with 0.01 M standard AgNO₃ solution using 5 wt % K₂CrO₄ as an indicator and the volume of the consumed AgNO₃ solution (V_{AgNO3}) was recorded. The ion exchange capability of the PDTP anion exchange membrane in Br form can be calculated as follows.

$$I E C ( {Br}^{-} ) = ( 0.01 \times {V}_{AgNO 3} ) / {M}_{dry} \qquad ( 1 )$$

### 3. Water Uptake (WU) and Swelling Ratio (SR)

A membrane sample (in Br or OH⁻ form) with a square shape (3.5 cm×3.5 cm) was dried in a vacuum oven at 80° C. for 24 hours and then dry weight (M_{dry}) and length (L_{dry}) were measured. After that, the sample was swollen in distilled water for 12 hours at 30° C., 60° C. and 80° C., respectively. The wet weight (M_{wet}) and length (L_{wet}) of the membrane sample were recorded after removing excess water from the surface. Water uptake (WU) and swelling ratio (SR) can be calculated according to the following equations.

$$W U ( \% ) = [ ( {M}_{wet} - {M}_{dry} ) / {M}_{dry} ] \times 100 \qquad ( 2 )$$

$$S R ( \% ) = [ ( {L}_{wet} - {L}_{dry} ) / {L}_{dry} ] \times 100 \qquad ( 3 )$$

The hydration number (A), which stands for the number of absorbed water molecules per ammonium group, is calculated using the following equation, where M_{H2O} is the relative molecular mass of water (18 g mol⁻¹).

$$∧ = ( W U \times 1000 ) / ( I E C \times {M}_{H 2 O} ) \qquad ( 4 )$$

### 4. Dynamic Vapor Sorption (DVS)

The water sorption behavior of the membrane samples was determined by dynamic vapor sorption (DVS; Surface Measurement Systems, UK) at different relative humidity values (0%, 18%, 36%, 54%, 72% and 90%) at 25° C. Before testing, the membrane samples were dried overnight in a vacuum oven at 100° C. to remove residual water. The relative humidity was increased automatically from 0% to 90% and then decreased incrementally from 90% to 0% with a 1-hour hold at every relative humidity stage to achieve equilibrium.

### 5. Ion Conductivity

The ion conductivity of the membrane samples was measured using an AC impedance analyzer (VSP and VMP3 Booster, Bio-Logic SAS, Grenoble, France) according to the four-point probe method in the frequency range of 100 Hz to 0.1 MHz. The rectangular sample (1.0 cm×3.0 cm) was connected with two platinum electrodes and then sealed in a fuel cell system with nitrogen purge. The length (L, cm) was the distance between the two platinum electrodes. The ohm impedance (R, kΩ) was measured at different temperatures (from 30° C. to 80° C.) under fully hydrated conditions. The ion conductivity (o) of the PDTP membranes at different relative humidities (0%, 25%, 50%, 75% and 100%) was measured at 60° C. with 200 mL min⁻¹ humidifying nitrogen purge. 0% relative humidity was achieved by purging with nitrogen. The ion conductivity (σ) of the membrane sample can be calculated according to the following equation.

$$σ = L / AR \qquad ( 5 )$$

where A (cm²) stands for the effective membrane area calculated from the thickness (T) and effective width (W) of the membrane.

### 6. Gas Permeability

A laboratory-made gas permeability testing system [a combination of a gas chromatograph (GC, 490 Micro GC, Agilent Technologies, USA) and two flow rate controllers (MFC, M3030V, Line Tech, Korea)] was used to measure the hydrogen permeability and water vapor permeability of the PDTP membrane, PFBP membrane and a commercial FAA-3-50 membrane (in halogen form) at 60° C. The gas permeability testing was performed at different relative humidities (from 0 to 90%) under 2.2 bar unilateral back pressure using the following equation.

$$P = ( {VM}_{gas} d / {P}_{feed} {RTA}_{p} ) \times ( dp / dt ) \qquad ( 6 )$$

where A (4.9 cm²), d (μm), P_{feed} and M_{gas} (g mol⁻¹) denote the effective area and thickness of the membrane, gas pressure and the molecular weight of the permeating gas, respectively. V (cm³), ρ (g cm⁻³) and R (L mmHg K⁻¹ mol⁻¹) are the volume of the measurement device, the density of the permeating gas and the gas constant, respectively, and dp/dt is the change in the pressure of the permeated gas as a function of time. The unit P is Barrer, where 1 Barrer=10⁻¹⁰ cm³ (STP) cm cm⁻² s⁻¹ cmHg⁻¹.

### 7. Intrinsic Viscosity

The intrinsic viscosity ([η]) of the polymer ionomers was measured using a viscometry system at 25° C. using a DMSO solvent. The viscometry system consisted of Schott Viscosystem (AVS 370, Germany) combined with an Ubbelohde viscometer (SI Analytics, Type 530 13: Capillary No. Ic, K=0.03) and a piston burette (Titronic Universal). A polymer solution was diluted gradually to five different concentrations and the efflux time was recorded automatically and repetitively five times. The reduced viscosity (η_{red}), inherent viscosity (ηᵢₙₕ) and intrinsic viscosity were calculated from the following equations.

$${η}_{red} = [ ( {t}_{1} / {t}_{0} ) - 1 ] / c \qquad ( 7 )$$

$${η}_{inh} = ( Int {t}_{1} / {t}_{0} ) / c \qquad ( 8 )$$

where t₁ denotes the efflux time of the polymer solution, to denotes the efflux time of the DMSO solution and c is the concentration of the corresponding polymer solutions.

After plotting η_{red} and ηᵢₙₕ versus c, respectively, the y-intercept values were obtained by extrapolating them to c=0. The intrinsic viscosity was obtained as the average of the y-intercept values.

### 8. Alkaline Stability

The PDTP-25 membrane was exposed to 1 M, 5 M and 10 M NaOH at 80° C. over 1500 hours. The Br conductivity and ¹H NMR spectrum were measured in different periods. Before testing, the PDTP membrane sample was washed several times with distilled water to remove residual salts (The alkali solution was refreshed weekly).

### 9. Thermal and Mechanical Stability

The thermal stability of the polymer ionomers (in I⁻ form) was measured using a thermogravimetric analysis instrument (TGA; Q500, New Castle, DE, USA) under nitrogen atmosphere. The sample was maintained in an isothermal condition at 100° C. for 10 minutes to remove any remaining water, and the temperature was increased from 50° C. to 800° C. with a heating rate of 10° C. min-1

The membrane samples were cut into a dumbbell-like shape with an effective area of 2 mm×10 mm using a standard mold. The tensile strength and elongation at break of the membrane samples (in I⁻ form) were measured using a universal testing machine (UTM; AGS-500NJ, Shimadzu, Tokyo, Japan) at room temperature with a stretching rate of 1 mm min⁻¹.

### 10. Dynamic Mechanical Analysis (DMA)

The membrane samples (in I⁻ form) were cut into a 0.9×2 cm rectangular shape and then measured using a dynamic mechanical analysis system (DMA, Q800, TA Instrument, DE, USA). The storage modulus and tan δ of the membrane samples were measured with a preload force of 0.01 N and a force track of 125% under nitrogen atmosphere. The target temperature was set to 450° C. at a heating rate of 4° C. min⁻¹. The peak of tan δ represents the glass transition temperature (T_{g}) of the membrane samples.

### 11. Morphology

The microphase morphology of the polymer ionomers (in I⁻ form) in the dry state were observed using Multimode 8 atomic force microscopy (AFM, Veeco, NY, USA) equipped with a Nanoscope V controller. The AFM testing was performed in a tapping mode. A scanning electron microscope (SEM, FE-SEM S-4800, Hitachi, Japan) was used to observe the surface and cross-sectional morphologies of the membranes and membrane electrode assemblies (at 15 kV).

### 12. Fuel Cell Performance

Single cell performance was tested on a fuel cell station (CNL, Seoul, Korea). The PDTP-25 membrane (thickness: 25±4 μm) was selected as an anion exchange membrane and PDTP-25, PDTP-75 and PFBP polymer ionomers were used as anion exchange ionomers. Pt/C (46.6 wt % Pt, Tanaka, Japan), Pt/C (40 wt % Pt, Hispec 4000, Alfa Aesar, USA) and PtRu/C (40 wt % Pt, 20 wt % Ru, Hispec 10000, Alfa Aesar, USA) were used as electrode catalysts. PDTP-25, PDTP-75 and PFBP copolymers were dissolved in DMSO and filtered with a 0.45-μm PTFE filter to prepare a 5 wt % polymer solution. Subsequently, the polymer solution and catalysts were added to an IPA/distilled water (10:1) solution to prepare a catalyst slurry, and the slurry was treated in an ultrasonic instrument for 45 minutes. Then, the catalyst slurry was coated onto both sides of the PDTP-25 membrane (in I⁻ form) with a metal catalyst loading of 0.26 mg/cm⁻² or 0.39 mg/cm⁻² to produce catalyst-coated membranes (CCMs). The slurry composition was anion exchange ionomer:total carbon:Pt=1:2:1.33 (in Hispec Pt/C-based slurry) or 1:1.78:1.55 (in TKK Pt/C-based slurry). In addition, the slurry was anion exchange ionomer:total carbon:PtRu=1:1.33:2 or 1:2.33:2. The prepared CCM was immersed in 1 M NaOH solution at room temperature for 12 hours and washed twice with distilled water before fuel cell performance testing. After that, the CCM was assembled with a gas diffusion layer, a PTFE-based gasket and a graphite bipolar plate into a 5-cm² single cell.

After humidifier and line heater temperatures reached the set values, the cell temperature was increased to 70° C. and the cell was activated at a constant voltage of 0.5 V and a H₂/O₂ flow rate of 1000/1000 mL min⁻¹ until a stable current density was established. Subsequently, the cell temperature was increased to 80° C. and the polarization curve (voltage-current curve) was recorded. The in-situ durability of the optimum cell was evaluated under a constant current density 0.4 A/cm² at 80° C. with a 200/200 mL min⁻¹ H₂/O₂ flow rate and 100% anode/cathode relative humidity. After the in-situ durability testing, the CCM disassembled from the membrane electrode assembly (MEA) was re-dissolved in DMSO-de to confirm the chemical structure of the anion exchange membrane and anion exchange polymer ionomers by ¹H NMR.

### [Test Results and Evaluation]

### 1. Synthesis of Poly (Alkyl-Aryl Piperidinium) Polymer Ionomer

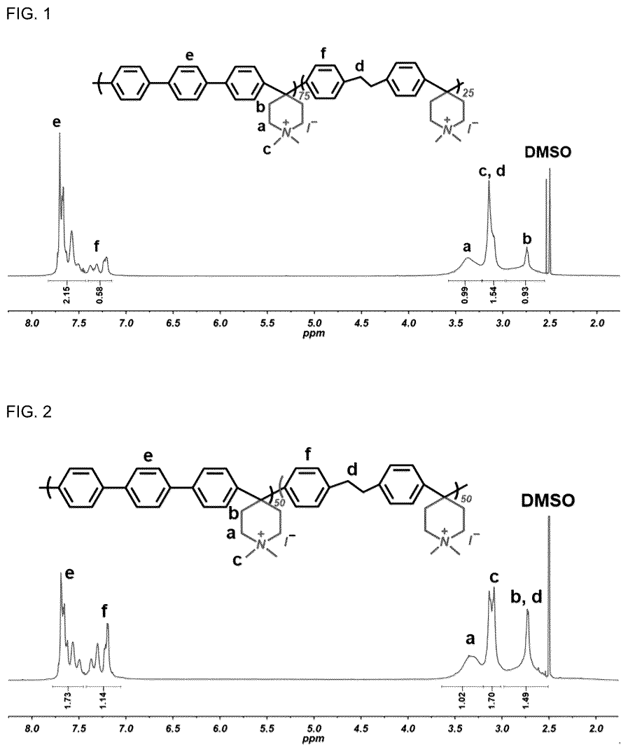

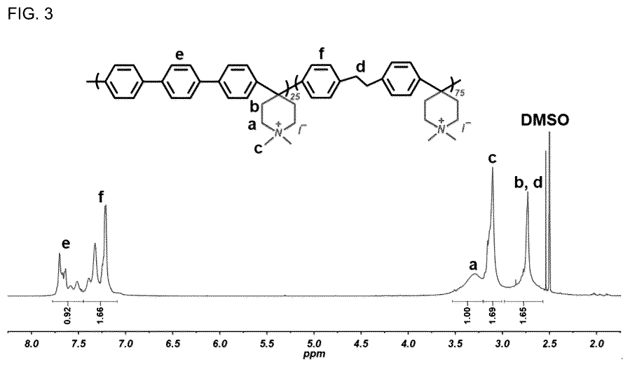

The chemical structure of the poly (alkyl-aryl piperidinium) polymer ionomers prepared in Examples 1-3 was confirmed by nuclear magnetic resonance (¹H NMR) analysis. FIG. 1 shows the nuclear magnetic resonance (¹H NMR) spectrum of PDTP-25 prepared in Example 1. FIG. 2 shows the nuclear magnetic resonance (¹H NMR) spectrum of PDTP-50 prepared in Example 2, and FIG. 3 exhibits the nuclear magnetic resonance (1H NMR) spectrum of PDTP-75 prepared in Example 3.

Prior to quaternization, 10% trifluoroacetic acid (TFA) was added to DMSO-d₆ in order to increase the solubility of some polymer and remove the negative effect of the H₂O peak (3.34 ppm) in ¹H NMR analysis. The chemical shift of TFA around 13 ppm was eliminated for better observation. Typically, the protons (a and b) in the piperidinium ring were split into different peaks by TFA before quaternization. Four split peaks with the same integrated area were observed around 3.50 ppm, 3.20 ppm, 2.90 ppm and 2.30 ppm. The chemical shift of N—CH₃ appeared around 2.77 ppm. After quaternization, the splitting phenomenon disappeared and the chemical shift of a, b and c protons in the piperidinium ring was observed at 3.35 ppm, 3.14 ppm and 2.86 ppm.

Accordingly, from FIGS. 1-3, it can be seen that the poly (alkyl-co-aryl piperidinium) polymers according to the present disclosure were synthesized.

### 2. Water and Gas Transport Behavior

Table 1 shows the ion exchange capability (IEC), water uptake (WU), swelling ratio (SR), OH-ion conductivity (o), hydration number (A) and intrinsic viscosity (n) of the PDTP-25 membrane, the PDTP-50 membrane and the PDTP-75 membrane prepared in Example 4, the PTP membrane prepared in Comparative Example 2 and the PFBP-14 membrane filed in Korean Patent Application No. 10-2020-0093640 by the inventors of the present disclosure as a control group.

TABLE 1

| | IEC (mmolg⁻¹) | | WU (%) | | | | SR (%) | | σ | | |
|---|---|---|---|---|---|---|---|---|---|---|---|
| | Titra/Theo | Titra | 30° C. | | 80° C. | | (OH⁻) | | (OH⁻) | | η |
| Membranes | (Br⁻) | (OH⁻) | Br⁻ | OH⁻ | Br⁻ | OH⁻ | 30° C. | 80° C. | 60° C. | λ | (dL/g) |
| PTP | 2.24/2.37 | 2.61 | 16.8 | 62.1 | 31 | 70.5 | 21.2 | 23.8 | 91 | 13.2 | 4.6 |
| PDTP-25 | 2.38/2.46 | 2.80 | 22.4 | 121 | 39.3 | 180 | 33.3 | 48.6 | 138 | 24 | 4.5 |
| PDTP-50 | 2.48/2.54 | 2.94 | 37.4 | >500 | — | — | 101 | — | 129 | >92 | 4.5 |
| PDTP-75 | 2.59/2.61 | 3.10 | 66.7 | >900 | — | — | ~200 | — | 156 | >161 | 5 |
| PFBP-14 | 2.86/2.86 | 3.43 | 51.8 | 330 | NE | 489 | 102 | 128 | 131 | 53 | 2.34 |

—: cannot be tested because of excessive swelling, NE: not evaluated, OH⁻ conductivity was tested at 100% relative humidity.

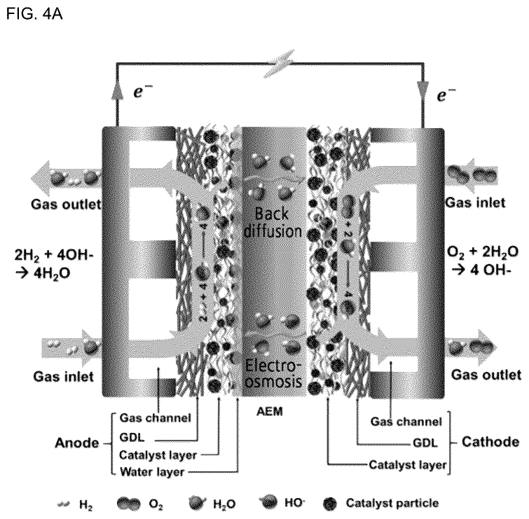

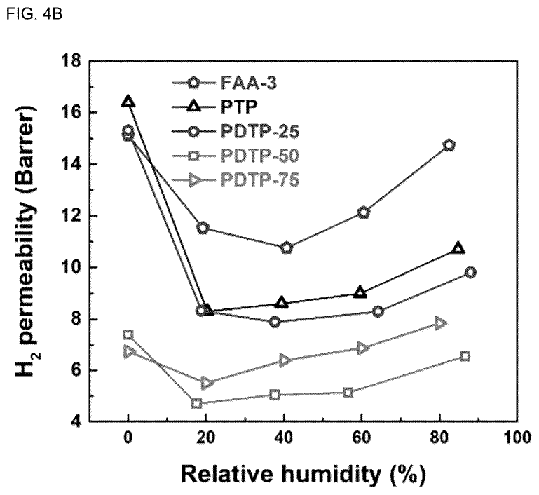

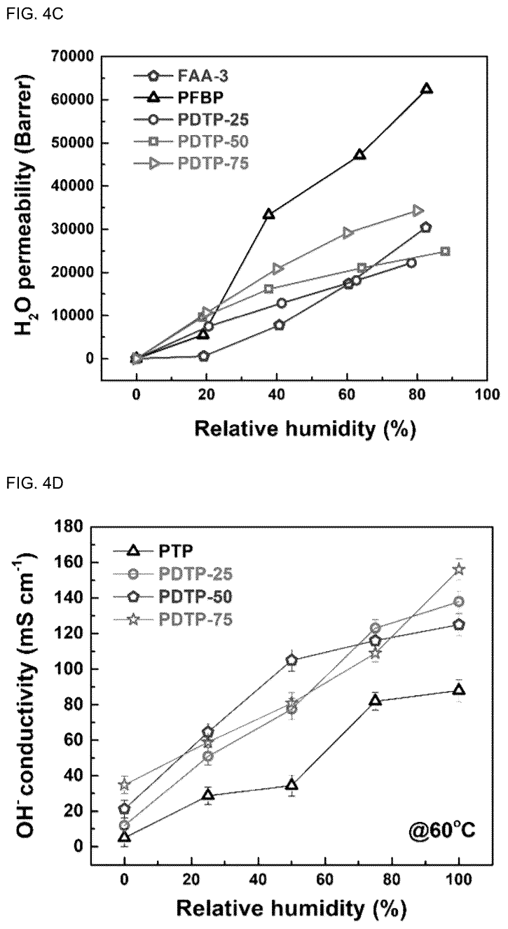

The water permeability characteristics of the anion exchange polymer ionomer and the anion exchange membrane are very important for water management in an anion exchange membrane fuel cells (AEMFCs). As seen from the schematic diagram of a membrane electrode assembly (MEA) with three-phase boundaries shown in FIG. 4A, while the anode is likely to flood due to electrochemical water generation, the cathode is inclined to dry out because of electrochemical water consumption.

In addition, it can be seen from Table 1 that a high mole fraction of diphenyl containing an aliphatic chain structure in the poly (alkyl-co-aryl piperidinium) polymer results in high ion exchange capability, water uptake, swelling ratio and hydration number. The PDTP anion exchange membranes display significant difference in water uptake, swelling ratio and hydration number. For example, the PDTP-75 membrane exhibits high water uptake and hydration number, while the PDTP-25 membrane displays moderate water uptake and a low swelling ratio (at 80° C.).

In addition, the dynamic vapor sorption (DVS) data revealed that the water sorption of the swollen PDTP anion exchange membrane at low relative humidity was much lower than liquid water uptake, implying that the polymer with high water (liquid) uptake can be used as an anion exchange ionomer. The water diffusivity of the PDTP-25 membrane, the PDTP-50 membrane and the PDTP-75 membrane prepared in Example 4 and the PTP membrane prepared in Comparative Example 2 calculated from DVS is provided in Table 2.

TABLE 2

| | |
|---|---|
| Relative | Water diffusivity (10⁻⁷ cm s⁻¹)* |

| humidity | PTP | PDTP-25 | PDTP-50 | PDTP-75 |
|---|---|---|---|---|
| 18% | 0.59 | 0.67 | 0.94 | 2.78 |
| 36% | 0.62 | 1.08 | 2.98 | 3.81 |
| 54% | 1.45 | 1.79 | 3.59 | 4.01 |
| 72% | 1.32 | 0.95 | — | — |
| 90% | 1.15 | — | — | — |

*Water diffusivity of anion exchange membranes (in OH⁻ form) at different relative humidities measured at 25° C.

Three molecules, hydrogen, oxygen and water, are involved in the electrode reaction of AEMFCs. The gas permeability of the anion exchange membrane was measured systematically at different relative humidities using a custom-made gas permeability testing system.

FIG. 4B shows the hydrogen permeability of the PDTP-25 membrane, the PDTP-50 membrane and the PDTP-75 membrane prepared in Example 4, the PTP membrane prepared in Comparative Example 2 and a commercial FAA-3 membrane as a control group at different relative humidities (in I⁻ form, measured at 60° C.). The hydrogen permeability of the PDTP membranes containing the aliphatic chain structure tends to decrease with increasing diphenyl mole fraction The humidified PDTP-25 membrane and PDTP-50 membrane displayed lower hydrogen permeability and superior fuel barrier properties (as compared to the commercial FAA-3 membrane and PTP membrane). This implies that they are gas-tight during fuel cell operation.

The hydrogen permeabilities of all the anion exchange membranes decreased at 18% relative humidity because water molecules blocked the micropores in the membranes. Thus, the hydrogen permeability tended to increase with relative humidity due to membrane swelling. This is a typical plasticization phenomenon in membranes for gas transport.

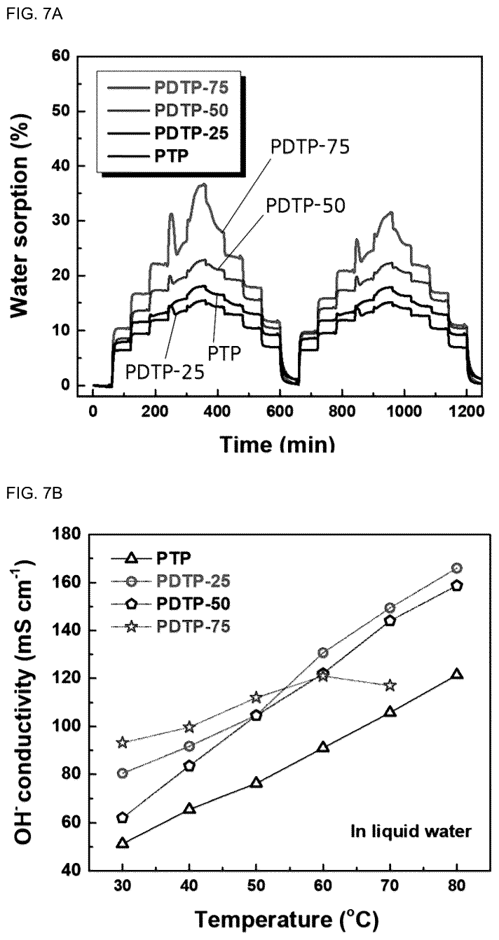

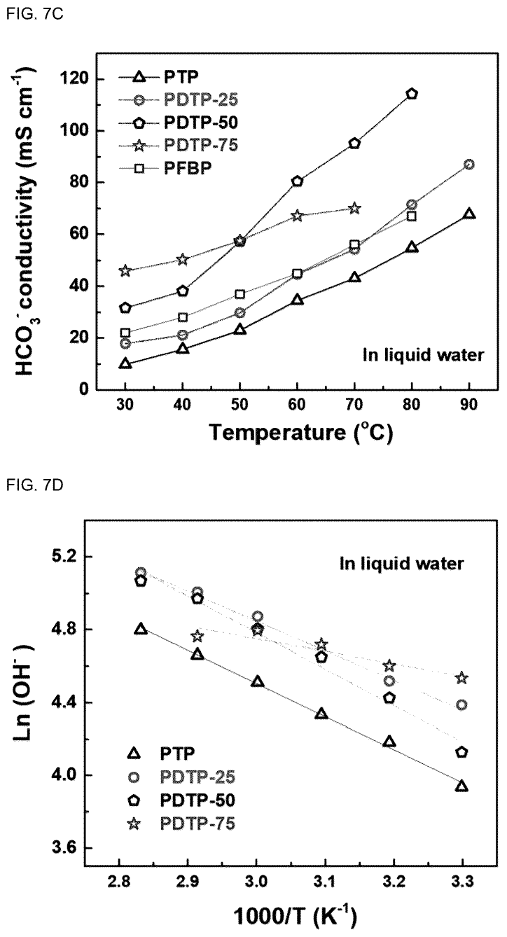

On the other hand, FIG. 4C indicates that the water vapor permeability of the PDTP membranes increases with the mole fraction of diphenyl containing the aliphatic chain structure. This phenomenon is consistent with the water sorption and diffusion behavior shown in FIG. 7A and Table 2. Meanwhile, the fluorene-containing PFBP membrane (the anion exchange membrane disclosed in Korean Patent Application No. 10-2020-0093640 filed earlier by the inventors of the present disclosure) exhibited higher water vapor permeability than the PDTP membranes. FIG. 4D indicates that the ion-conducting behavior of the PDTP membranes at different relative humidities is similar to the water behavior.

### 3. Dynamic, Mechanical, Morphological and Ion Conductivity Behavior

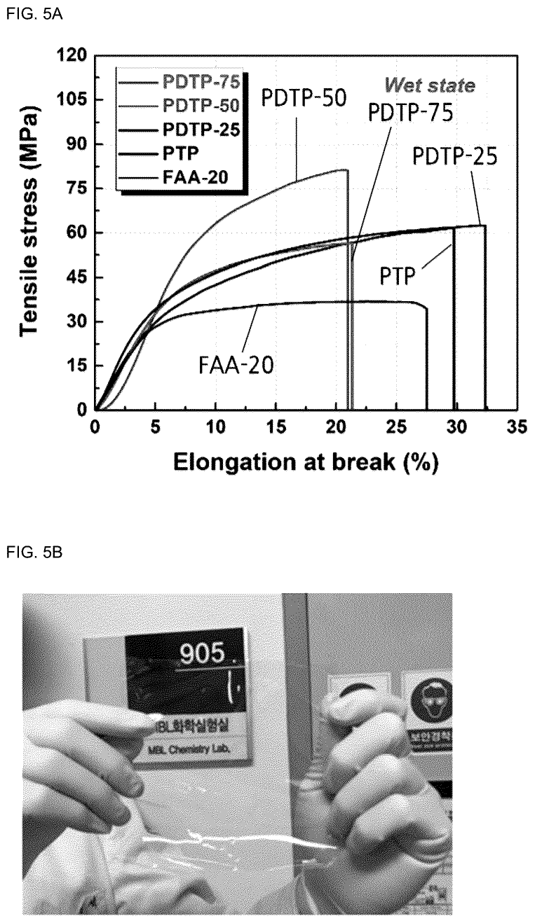

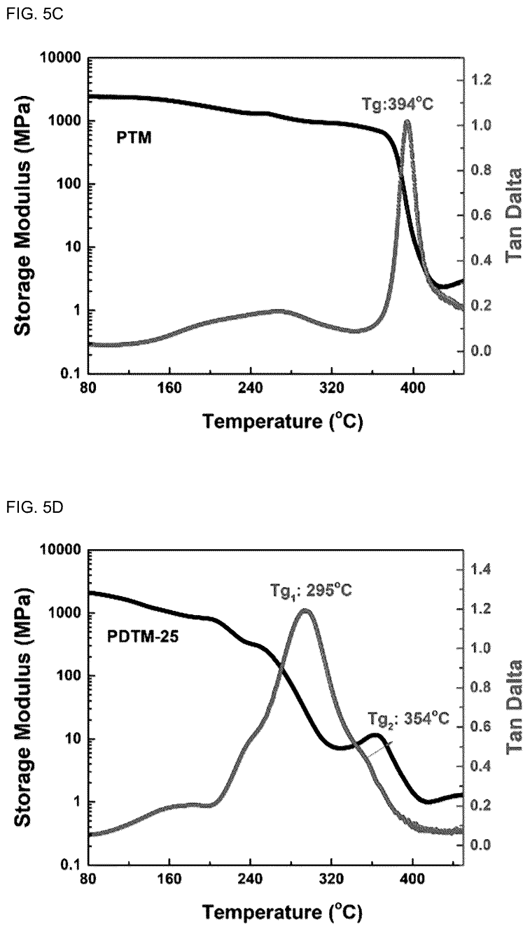

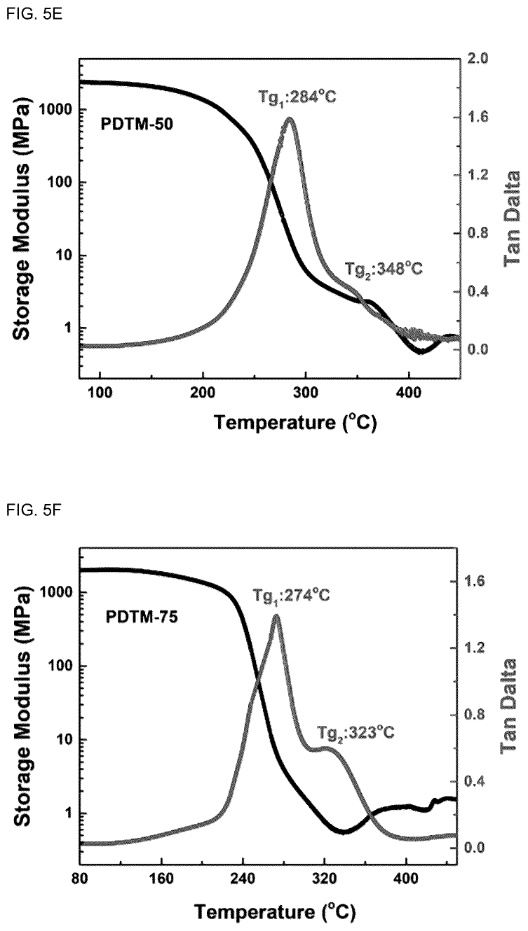

FIG. 5A shows the mechanical properties of the PDTP-25 membrane, the PDTP-50 membrane and the PDTP-75 membrane prepared in Example 4, the PTP membrane prepared in Comparative Example 2 (in I⁻ form) and a commercial FAA-3-20 membrane as a control group (in Cl⁻ form) at wet state, FIG. 5B shows the photographic image of the transparent and strong PDTP-25 membrane (thickness: 25 μm) and FIGS. 5C to 5F show the storage modulus and tan δ of the membranes [(c) PTP membrane, (d) PDTP-25 membrane, (e) PDTP-50 membrane and (f) PDTP-75 membrane (in I⁻ form)].

The PDTP membranes prepared in Example 4 exhibited superior tensile strength and elongation at break, and the values were higher than those of the PTP membrane prepared in Comparative Example 2, indicating that the diphenyl block containing the aliphatic chain structure enhances the mechanical properties of the PDTP membranes. In addition, the mechanical properties of the PDTP membranes were very superior as compared to the commercial FAA-3-20 membrane. In particular, the PDTP-50 membrane showed the highest tensile strength but showed relatively lower elongation at break (as compared to the PDTP-25 membrane and the PTP membranes). The PDTP-25 membrane showed superior dimensional stability, mechanical properties and film-forming ability, indicating that it is suitable as an anion exchange membrane for a fuel cell.

DMA analysis revealed that the PDTP membranes exhibited a high storage modulus (over 1900 MPa at 80° C.) and superior dynamic mechanical properties. The glass transition temperature (T_{g}) of the PDTP membranes decreased with increasing diphenyl content. The PDTP-25 membrane, the PDTP-50 membrane and the PDTP-75 membrane had two glass transition temperatures. The PTP membrane exhibited only one glass transition temperature. The glass transition temperature (T_{g1}) is due to the presence of diphenyl while the glass transition temperature (T_{g2}) is due to terphenyl.

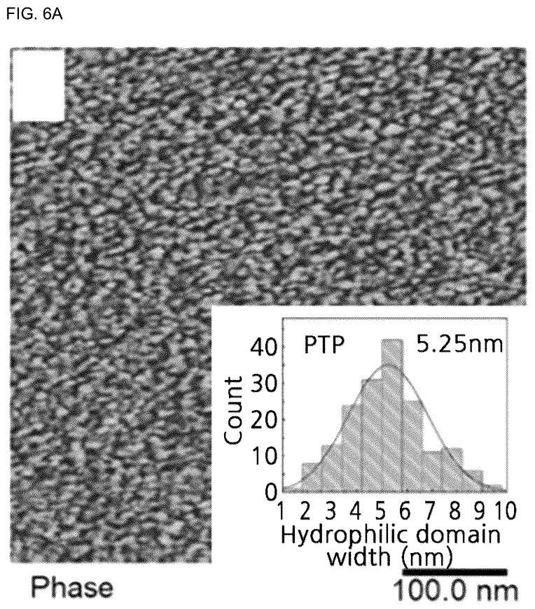

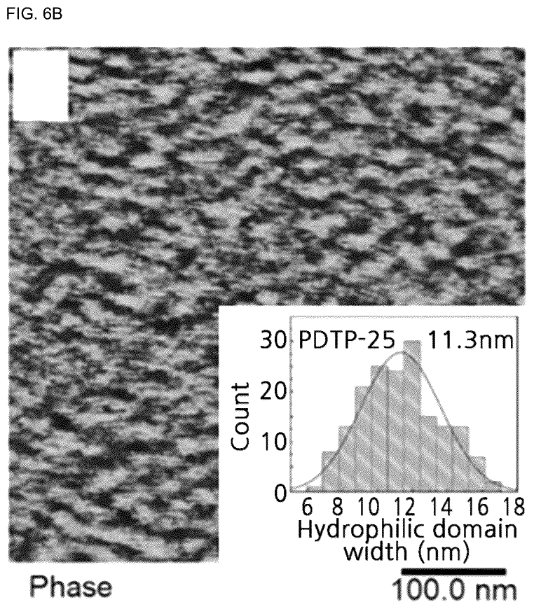

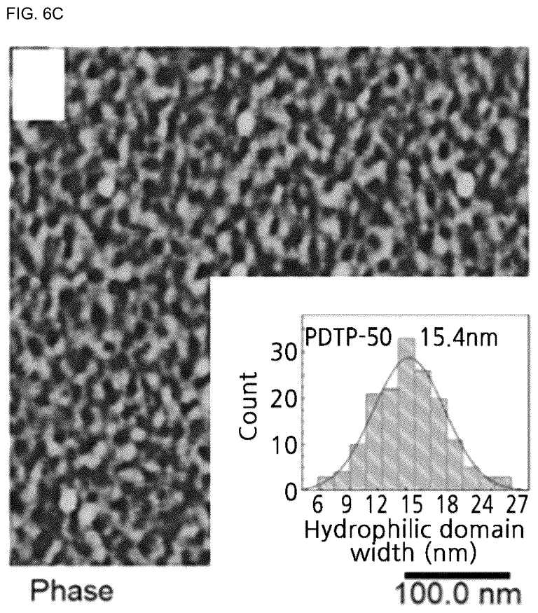

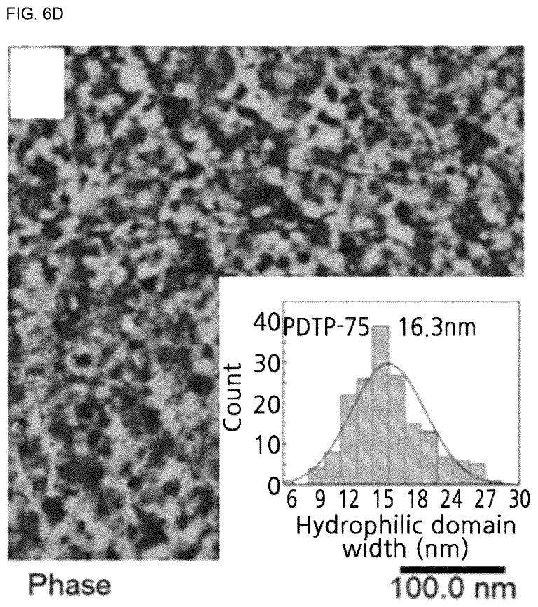

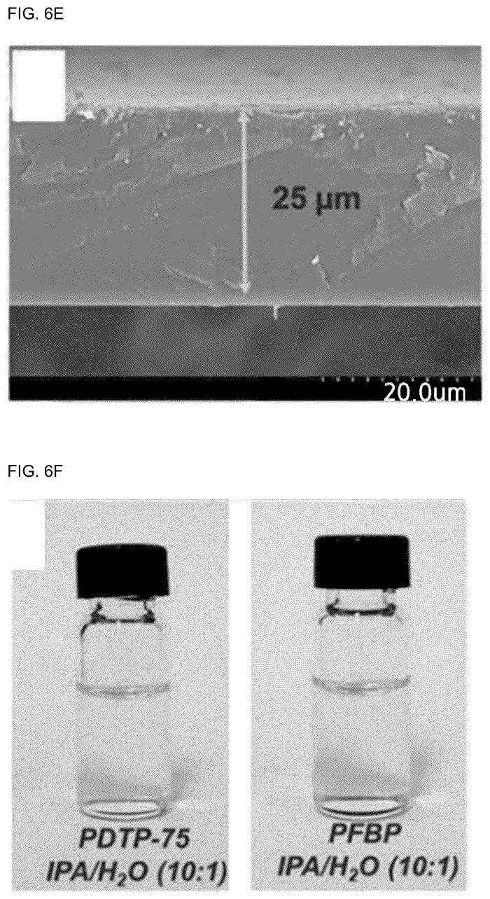

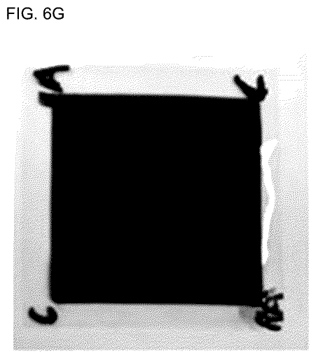

FIGS. 6A to 6G shows the atomic force microscopy (AFM) images of (FIG. 6A) the PTP membrane prepared in Comparative Example 2 and (FIG. 6B) the PDTP-25 membrane, (FIG. 6C) the PDTP-50 membrane and (FIG. 6D) the PDTP-75 membrane prepared in Example 4 (in I⁻ form), (FIG. 6E) the cross-sectional scanning electron microscopy (SEM) image of the PDTP-25 membrane and the photographs of (FIG. 6F) the PDTP-75 and PFBP ionomer solutions (in isopropyl alcohol:deionized water=10:1) and (FIG. 6G) the PDTP-based membrane electrode assembly (MEA).

FIGS. 6A to 6D show that the diphenyl segments significantly improve the microphase separation of the PDTP membranes. The dark regions denote the ammonium- and water-containing hydrophilic phases while the yellow regions indicate the polymer main chain-aggregated hydrophobic phases. The hydrophilic phase increased from 5.3 nm to 16.3 nm with increasing diphenyl content. From a combination of the glass transition temperature behavior and the morphology results, it can be seen that the PDTP-75 membrane and the PDTP-50 membrane with two glass transition temperatures displayed a larger hydrophilic channel width than the PTP membrane or the PDTP-25 membrane.

FIG. 7A shows the DVS data [25° C., different relative humidities (0%, 18%, 36%, 54%, 72% and 90%)] and Arrhenius plots based on (FIG. 7B) OH-conductivity, (FIG. 7C) the HCO₃⁻ conductivity and (FIG. 7D) OH-conductivity of the PDTP-25 membrane, the PDTP-50 membrane and the PDTP-75 membrane prepared in Example 4 and the PTP membrane prepared in Comparative Example 2.

Interestingly, the ion conductivity of thee PDTP membranes showed a similar phenomenon to the glass transition temperature and microphase separation morphology behaviors. The OH⁻ and HCO₃⁻ conductivities of the PDTP membranes tend to increase with increasing diphenyl content (at low relative humidity and temperature), and these are much higher than that of the PTP membranes. This is attributed to higher ion exchange capability values and preferable microphase separation. The PDTP-75 membrane displayed the highest OH-conductivity of 158 mS cm⁻¹ (at 60° C. and 100% relative humidity), and the PDTP-50 membrane showed the highest HCO₃⁻ conductivity of 118 mS cm⁻¹ (at 80° C.) (see FIG. 7C). In addition, the activation energy of the PDTP membranes tends to decrease with increasing diphenyl content, implying that the PDTP membranes possess lower ion-conducting barriers than the PTP membranes (see FIG. 7D). However, when the mole fraction of the diphenyl segment was higher than 50%, the PDTP-75 membrane exhibited excessive water sorption and swelling ratio which are detrimental to their ion conductivity. Consequently, the PDTP-25 membrane with the most superior mechanical properties and reasonable ion conductivity properties is regarded as the most appropriate candidate for anion exchange membranes.

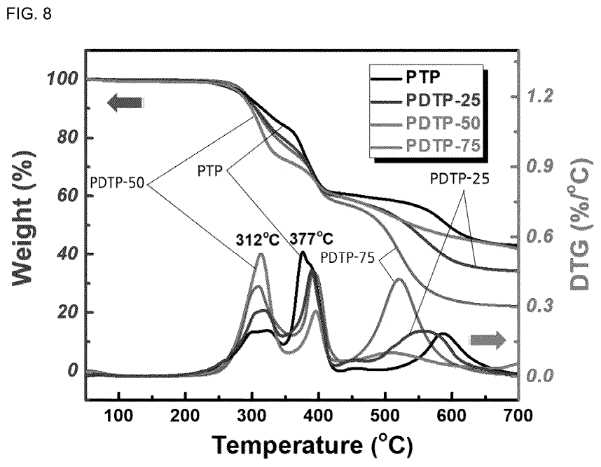

FIG. 8 shows the thermogravimetric analysis (TGA) and derivative curves of the PDTP-25 membrane, the PDTP-50 membrane and the PDTP-75 membrane prepared in Example 4 and the PTP membrane prepared in Comparative Example 2. The result indicates that the PDTP membranes are thermally stable below 190° C.

### 4. Fuel Cell Performance

Water behavior is crucial for AEMFCs. A thin PDTP-25 membrane with the best mechanical strength and high dimensional stability was selected as the most appropriate anion exchange membrane, while the PDTP-25 polymer ionomer, the PDTP-75 polymer ionomer and the PFBP polymer ionomer (the anion exchange polymer ionomer disclosed earlier in Korean Patent Application No. 10-2020-0093640 by the inventors of the present disclosure) with different water transport behaviors, IEC values and phenyl contents were used as binders. For convenience, the anion exchange polymer ionomers used in the anode (A) and the cathode (C) were named A/C AEIs. All the AEIs were soluble in isopropyl alcohol (IPA) and deionized water (DI) solution. A typical membrane electrode assembly (MEA) of PDTP membrane with the anion exchange polymer ionomer is shown in FIG. 6G.

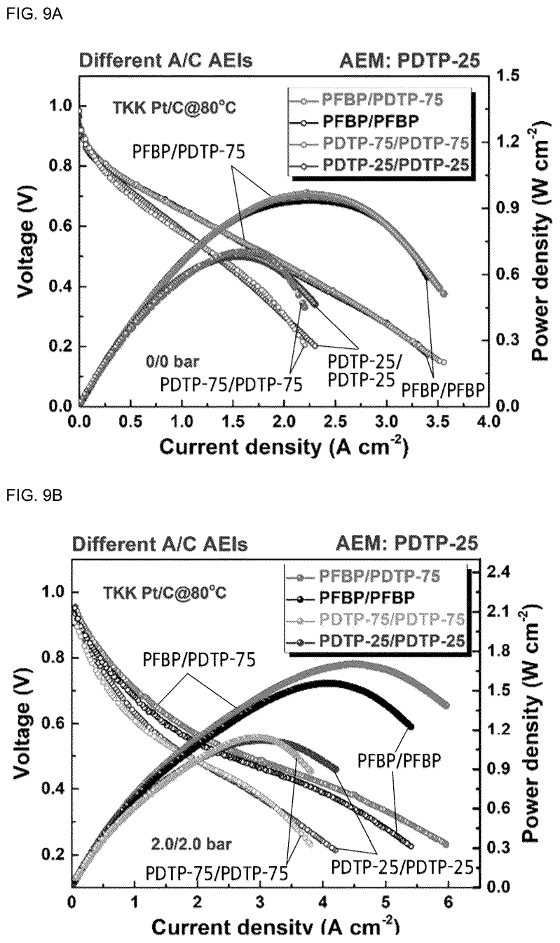

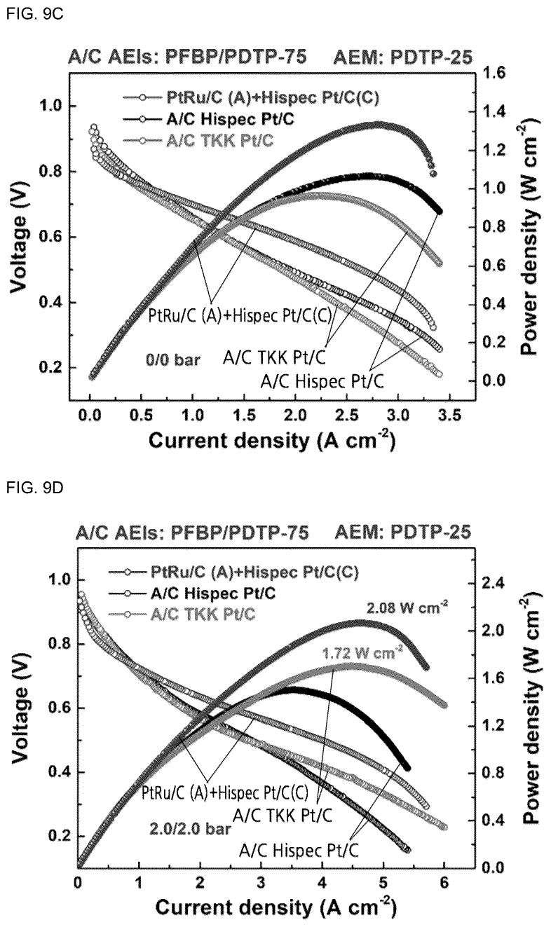

FIGS. 9A to 9D show the performance of anion exchange membrane fuel cells (AEMFCs) having various anode/cathode ionomers based on the PDTP-25 membrane (thickness: 25±3 μm) [80° C., 1,000/1,000 anode/cathode H₂/O₂ flow rate, various anode/cathode catalysts (ionomer:total carbon:metal=1:2:1.33, Hipsec Pt/C-based slurry, 1:1.78:1.55, TKK Pt/C-based slurry, and 1:1.33:2, PtRu/C-based slurry)]. FIG. 9A anode/cathode 0.26 mg cm⁻² TKK Pt/C, 0/0 bar anode/cathode back pressure, FIG. 9B, anode/cathode 0.26 mg cm⁻² TKK Pt/C, 0/0 bar anode/cathode back pressure. 2.0/2.0 bar anode/cathode back pressure, FIG. 9C anode/cathode PFBP/PDTP-75 ionomers, 0/0 anode/cathode back pressure, three types of anode/cathode catalysts with 0.26 mg cm⁻² loading: Pt—Ru/C anode and Hispect Pt/C cathode, anode/cathode Hispec Pt/C anode, and anode/cathode TKK Pt/C, FIG. 9D anode/cathode PFBP/PDTP-75 ionomers, 2.0/2.0 bar anode/cathode back pressure, three types of anode/cathode catalysts with 0.26 mg cm⁻² loading: Pt—Ru/C anode and Hispect Pt/C cathode, anode/cathode Hispec Pt/C anode, and A/C TKK Pt/C.

As shown in FIG. 9A, the PFBP/PDTP-75 A/C AEI exhibited the highest peak power density (PPD) of 0.97 W cm⁻² (at 80° C. with 0/0 back pressure). The PPD of the PFBP/PDTP-75 A/C AEI was close to that of the PFBP/PFBP A/C AEI but was significantly higher than the PDTP-75/PDTP-75 or the PDTP-25/PDTP-25. On the other hand, the PFBP/PDTP-75 displayed the best performance of 1.7 W cm⁻² (at 2.0/2.0 bar back pressure) (see FIG. 9B). PFBP exhibited superior cell performance for the cathode due to superior water permeability, while the PDTP-75 ionomer exhibited superior performance for the anode because its high water uptake and low phenyl content avoided the drying problem. On the other hand, PDTP-25 and PDTP-75 showed limited PPD when used in the cathode, and PDTP-25 with low water vapor permeability was detrimental to water back diffusion. In addition, PDTP-75 was not a good choice for the cathode due to excessive water absorption (flooding issues). These results revealed that various properties should be considered for use in the cathode or the anode.

Moreover, the commercial FAA-3-20 membrane and Fumion ionomer were used as control groups. The FAA-3-20 membrane, wherein PDTP-75 and PFBP AEIs were used in the anode and the cathode, showed similar cell performance (PPD=0.8 W cm⁻²), while PDTP-25/PDTP-25 exhibited low PPD (˜0.6 W cm⁻²) due to low water permeability. On the other hand, the PFBP or PDTP AEI exhibited much higher performance than the commercial Fumion ionomer.

The effect of different catalysts in the PFBP/PDTP-75 fuel cell was investigated. FIG. 9C and d indicate that the AEMFC with Pt—Ru/C displayed superior performance as compared to the cell using Pt/C due to lower phenyl adsorption effects and faster hydrogen oxidation reaction. In addition, the TKK Pt/C anode showed lower PPD as compared to the Hispec's product (no back pressure). However, comparable or even higher performance was observed when back pressure was applied. It is thought that the difference between the two types of Pt/C is related to different carbon contents which impact the anode flooding. The PPD of the Pt—Ru/C cell was 1.4 W cm⁻² (0/0 back pressure) and 2.08 W cm⁻² (2.0/2.0 bar) (at 80° C., 0.26 mg cm⁻² loading, hydrogen/oxygen). The Pt—Ru/C, Hispec Pt/C, and TKK Pt/C showed improvement in PPD performance of 54%, 34%, and 77%, respectively, when back pressure was applied.

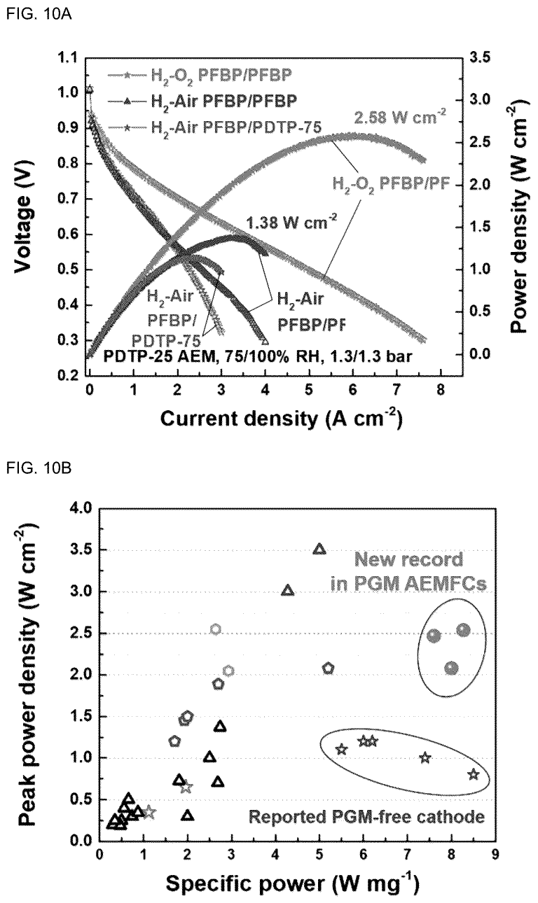

FIG. 10A shows the performance of anion exchange membrane fuel cells (AEMFCs) based on the PDTP-25 membrane (thickness: 22±3 μm) and various cathode/anode ionomers [testing conditions: 0.39 mg cm⁻² Pt—Ru/C in the anode along with carbon powder (ionomer:total carbon:Pt—Ru=1:2.33:2), 0.26 mg cm⁻² Hispec Pt/C in the cathode (ionomer:total carbon:metal=1:2:1.33), 1,000/1,000 mL min⁻¹ H₂—O₂ flow rate, 1,000/2,000 mL min⁻¹ H₂-air (CO₂ free) flow rate, 1.3/1.3 bar back pressure] and FIG. 10B shows the comparison of specific power and power density of a previously known AEMFC and a commercial AEMFC (anode/cathode PGM catalysts).

The PPD of the AEMFC using the anion exchange membrane according to the present disclosure was improved up to 2.58 W cm⁻² at a limiting current density over 7.6 A cm⁻² at 80° C. (Pt—Ru/C catalyst loading was increased to 0.39 mg cm⁻², and the ratio of AEI, carbon and catalyst metal is shown in FIG. 10A. Moreover, the same AEMFC reached a PPD of 1.38 W cm⁻² under H₂-air (CO₂-free) conditions. The reported PPD and limiting current density are the new records for the anion exchange membrane made without reinforcing support. Although few PTFE-reinforced PNB membrane-based AEMFCs can achieve PPDs higher than 3 W cm⁻², these cells are expensive because they rely on high catalyst loadings (0.7 mg cm⁻² or higher).

FIG. 10B summarizes the relationship between PPD and loading amount. The specific power of the AEMFC (7.1-8.2 W mg⁻¹) was higher than that of the conventional PGM-based AEMFCs (˜5 W cm⁻²). The AEMFC of the present disclosure exhibits very superior specific power even compared to the PGM-free anode.

### 5. Ex-Situ and In-Situ Durability

The ex-situ durability of the PDTP-25 membrane was analyzed by 1H NMR spectroscopy after alkaline exposure.

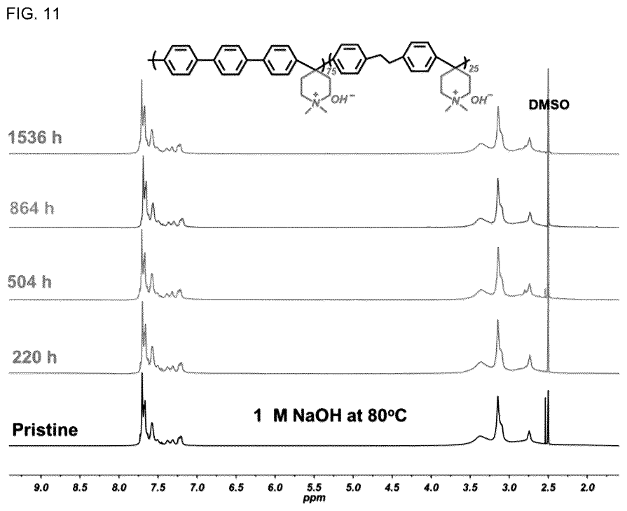

FIG. 11 shows the nuclear magnetic resonance (¹H NMR) spectra of the PDTP-25 membrane prepared in Example 4 depending on the time in a 1 M NaOH solution at 80° C. (No degradation of piperidinium groups was detected). FIG. 11 indicates no chemical degradation of the PDTP-25 membrane even after treatment with 1 M NaOH solution at 80° C. for 1500 hours. This implies that the PDTP-25 membrane has excellent ex-situ stability, contributed from the presence of highly stable dimethyl piperidinium (DMP) groups and the aryl ether-free polymer main chain.

In addition, the in-situ durability of the PDTP membrane-based fuel cell was tested. FIG. 12A shows the in-situ durability of a fuel cell using the PDTP-25 membrane prepared in Example 4 (80° C., 200/200 mL min⁻¹ flow rate, 0.33 mg cm⁻² loading of Hispec Pt/C, 0.4 A cm⁻² current density) and the -situ durability of a fuel cell using a commercial FAA-3-20 membrane (60° C., 200/200 mL min⁻¹ flow rate, 0.33 mg cm⁻² loading of Hispec Pt/C, 0.2 A cm⁻² current density) and FIG. 12B shows the nuclear magnetic resonance (¹H NMR) spectra of the PDTP-25 membrane and PFBP/PDTP-25 ionomers disassembled from the membrane electrode assembly (MEA) before and after the in-situ durability for 100 hours.

FIG. 12A shows a slight voltage loss during the initial 100 hours (0.4 A cm⁻², 80° C., 200/200 mL min⁻¹, hydrogen/oxygen). In comparison, the commercial FAA-3-20 membrane exhibited a rapid voltage loss within 40 hours. ¹H NMR analysis after the in-situ test revealed that there was no degradation. The unidentified peaks around 4 ppm and 5 ppm belong to impurities. According to recent discoveries, the in-situ durability of the MEA is strongly dependent on water management and system optimization and the cell voltage can be recovered after refreshing the MEA.

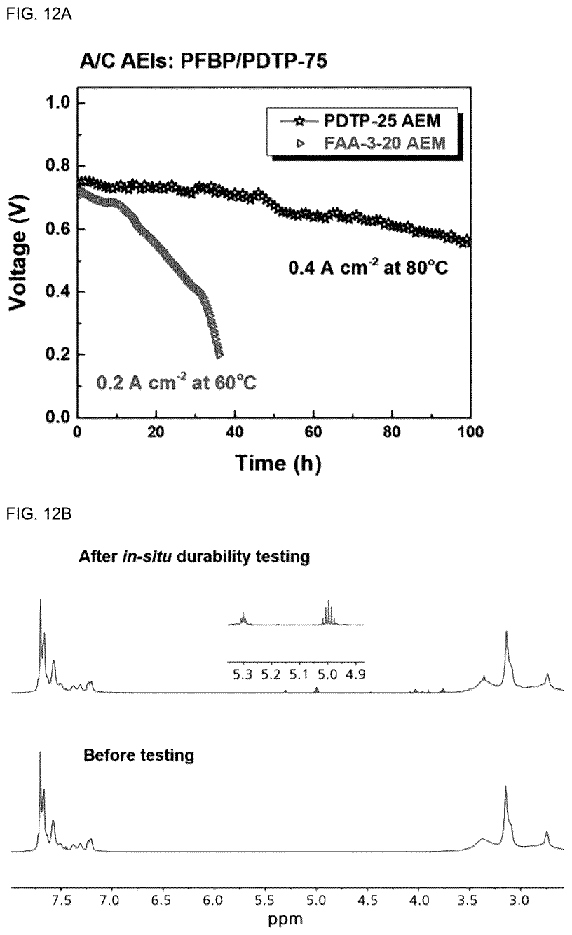

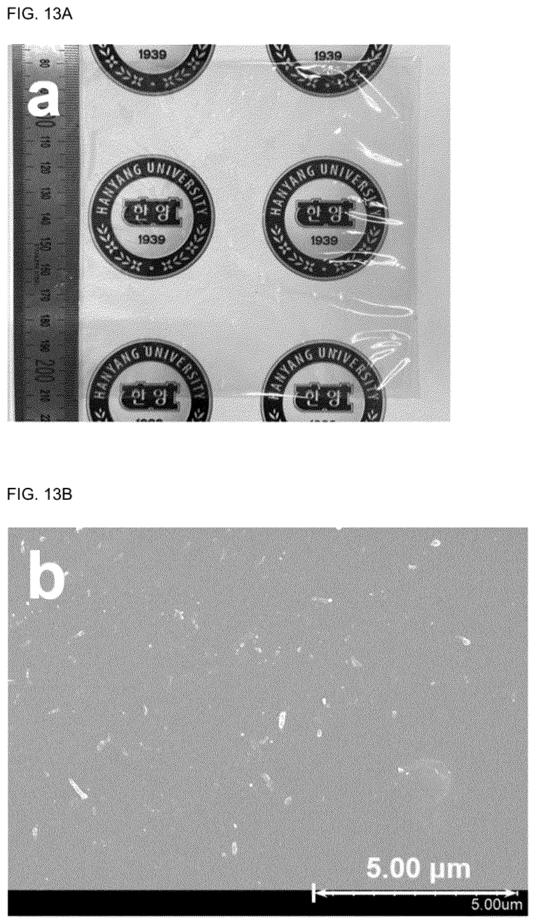

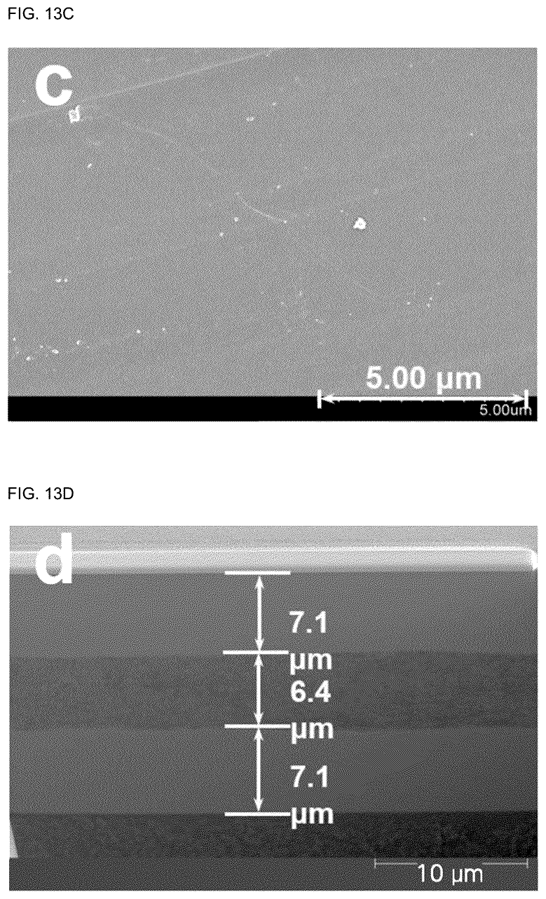

The physical properties and performance of the anion exchange composite membrane according to the present disclosure were also tested similarly to the anion exchange membranes, and the results are shown in FIGS. 13-23.

FIG. 13A shows the photographic image of the anion exchange composite membrane prepared in Example 5 and FIG. 13B to 13D show the scanning electron microscopy (SEM) images showing its morphology. It was confirmed visually that a transparent and uniform membrane was prepared. As a result of observing the morphology by scanning electron microscopy (SEM), it was confirmed that the poly (alkyl-co-aryl piperidinium) polymer ionomer was impregnated uniformly in the porous polymer support.

FIGS. 14A and 14B show the UV transmittance of PDTP-25 membranes in the anion exchange composite membrane prepared in Example 5 and the anion exchange membrane prepared in Example 4 (PDTP) as a measure of transparency [(FIG. 14A) I⁻ form, (FIG. 14B) OH⁻ form]. The composite membrane showed transparency similar to that of the single membrane, and the transparency varied depending on the thickness of the support.

FIG. 15 shows the mechanical properties of PDTP-25 membranes in the anion exchange composite membrane prepared in Example 5 and the anion exchange membrane prepared in Example 4 (PDTP) and a porous polyethylene support as a control group. The tensile strength and elongation at the break of the composite membrane were improved significantly due to the porous polymer support.

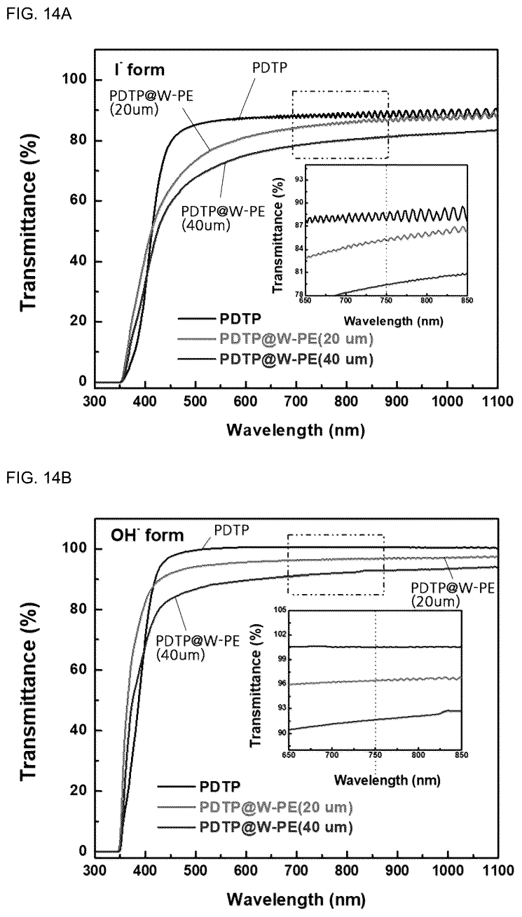

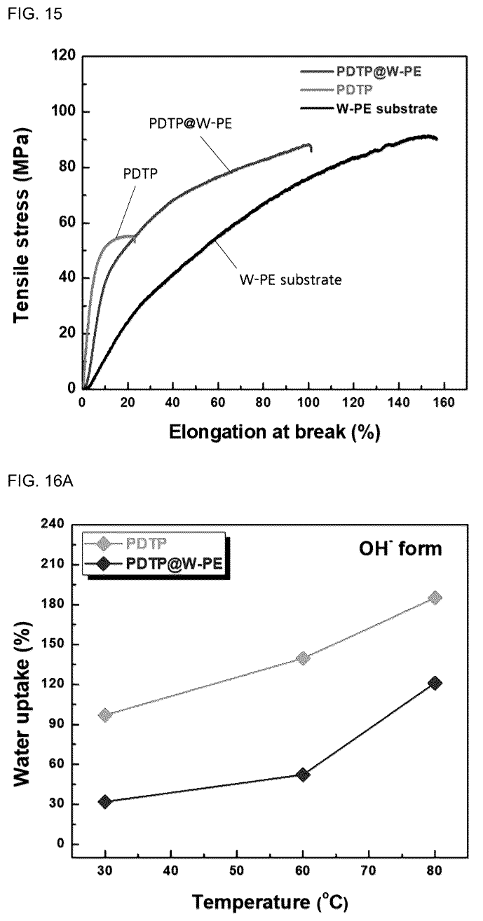

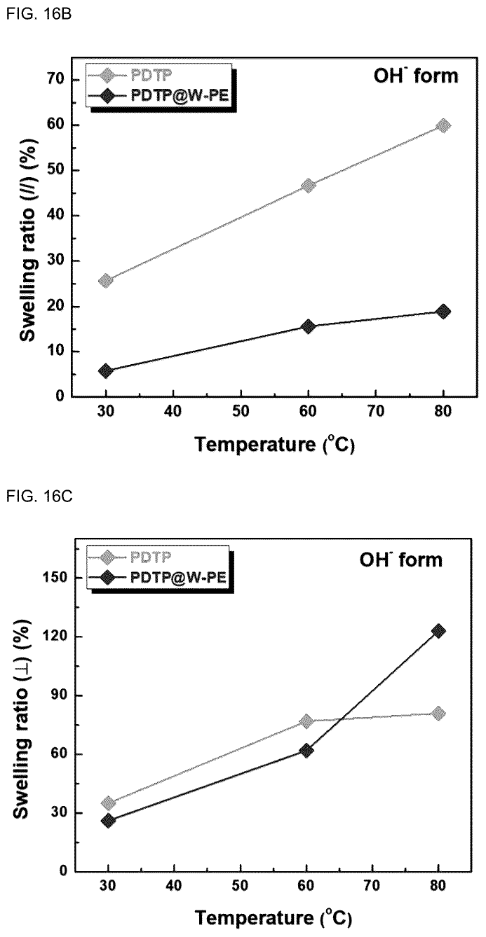

FIGS. 16A to 16C show the dimensional stability of PDTP-25 membranes in the anion exchange composite membrane prepared in Example 5 and the anion exchange membrane prepared in Example 4 (PDTP). It can be seen that the dimensional stability of the composite membrane was improved because the water uptake and swelling ratio were decreased.

FIG. 17A shows the hydrogen permeability and FIG. 17B shows the water permeability of PDTP-25 membranes in the anion exchange composite membrane prepared in Example 5 and the anion exchange membrane prepared in Example 4 (PDTP) and a commercial anion exchange membrane (FAA-3-50) as a control group. The composite membrane showed relatively lower permeability as compared to the single membrane.

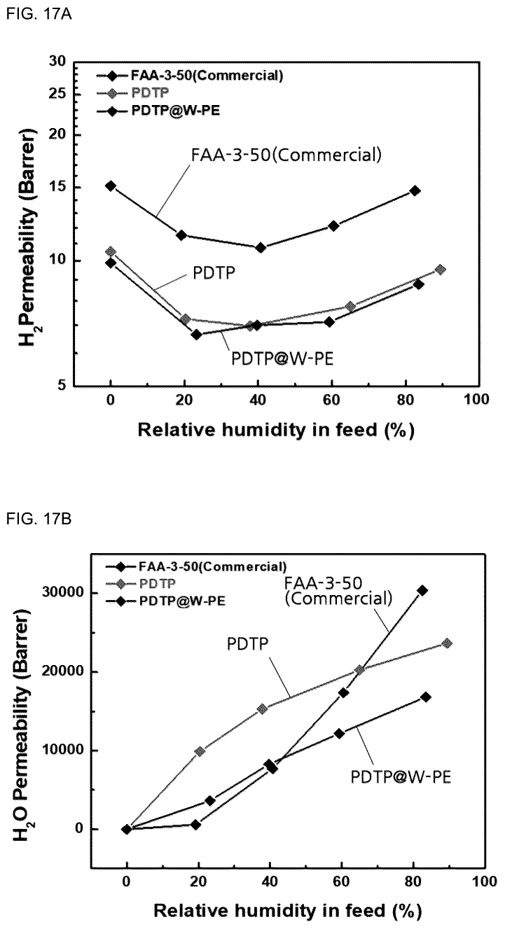

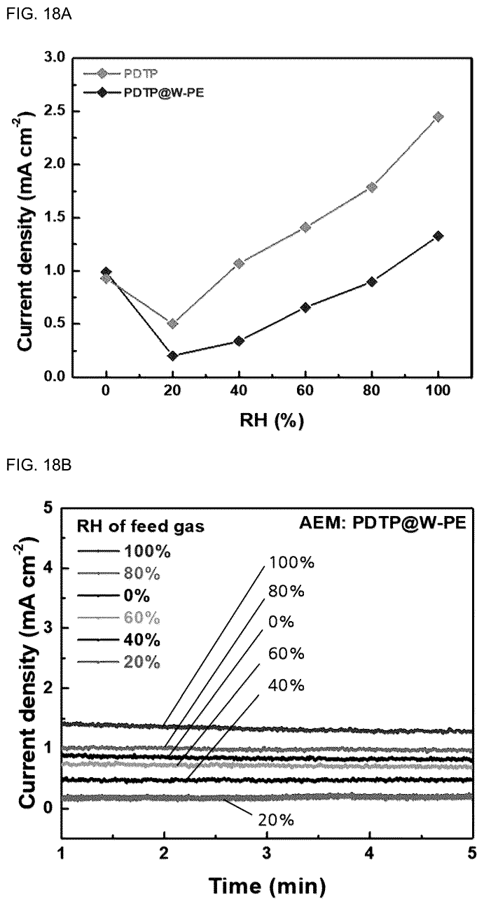

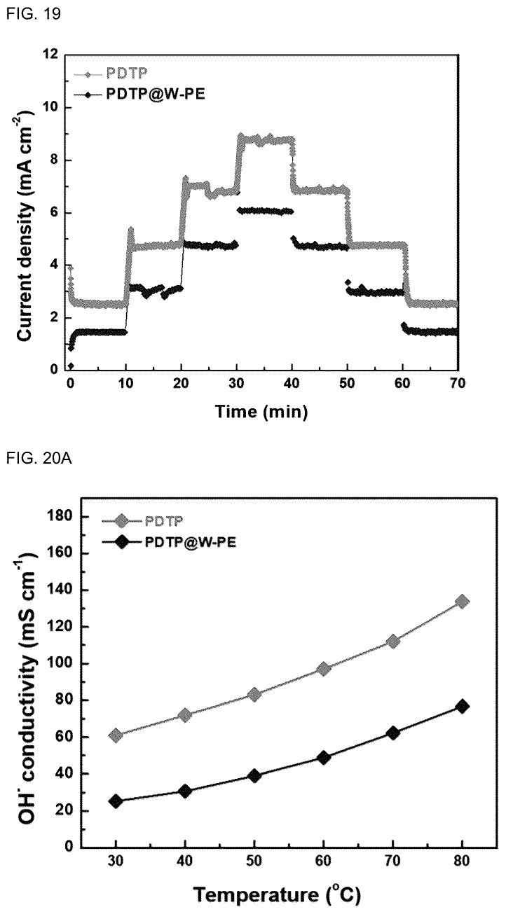

The result for the composite membrane shown in FIGS. 17A and 17B reveals the effect of preventing the crossover phenomenon during the operation of the alkaline fuel cell. It was confirmed by FIGS. 18-19 that current density is lower as compared to the single membrane due to crossover.

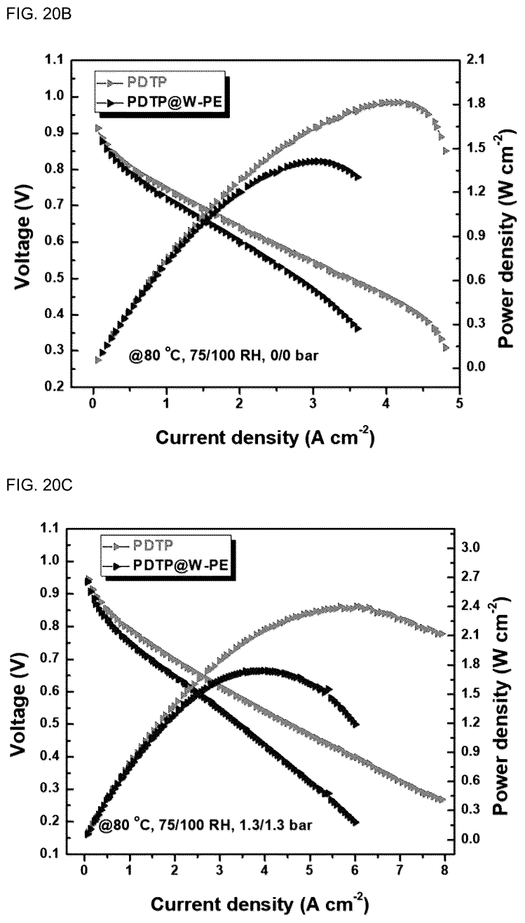

FIGS. 20A to 20C show the fuel cell performance of PDTP-25 membranes in the anion exchange composite membrane prepared in Example 5 and the anion exchange membrane prepared in Example 4 (PDTP). As expected, the composite membrane shows slightly lower conductivity due to the presence of the non-conductive porous polymer support.

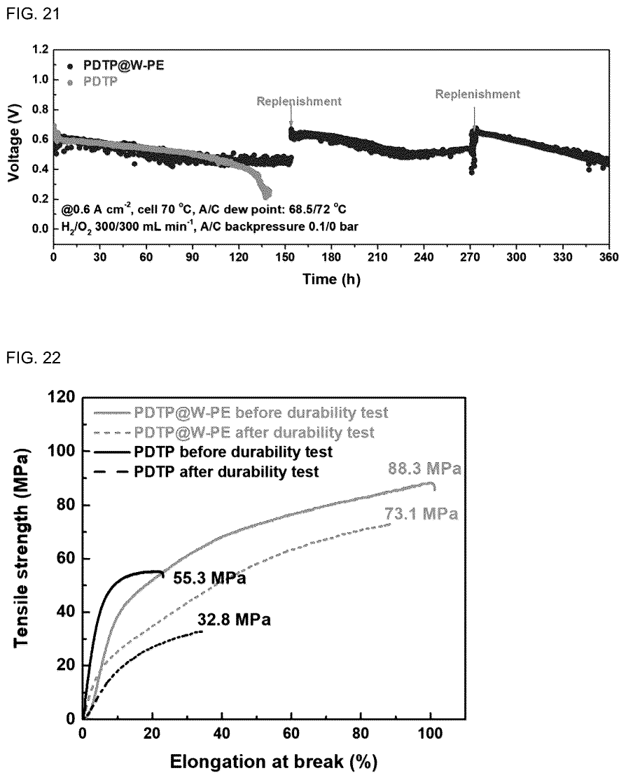

However, as shown in FIG. 21, which shows a result of evaluating the long-term lifetime of PDTP-25 membranes in the anion exchange composite membrane prepared in Example 5 and the anion exchange membrane prepared in Example 4 (PDTP), the composite membrane exhibited improved long-term lifetime characteristics due to superior mechanical properties and could be operated repeatedly through replenishment.

FIG. 22 shows the change in the mechanical strength of PDTP-25 membranes in the anion exchange composite membrane prepared in Example 5 and the anion exchange membrane prepared in Example 4 (PDTP) before and after the evaluation of long-term lifetime. The composite membrane showed less change in mechanical strength before and after the evaluation of long-term lifetime, as compared to the single membrane, and still showed good results.

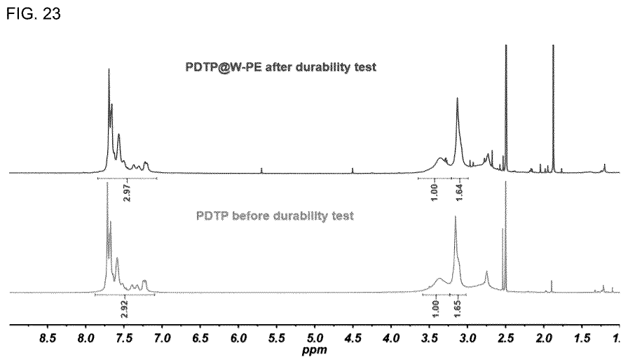

FIG. 23 shows the nuclear magnetic resonance (¹HNMR) spectra of the anion exchange composite membrane prepared in Example 5 before and after the evaluation of long-term lifetime. The composite membrane showed high durability since the proportion of ammonium groups was maintained constant.

1. A poly (alkyl-aryl piperidinium) polymer ionomer having a repeating unit represented by any one selected from <Chemical Formula 1> to <Chemical Formula 3>: 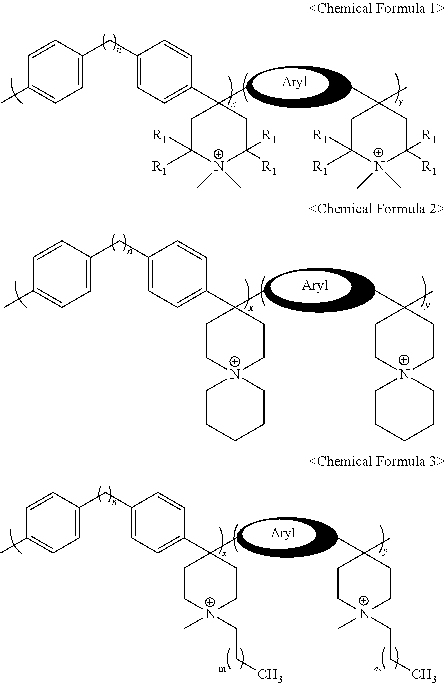
wherein Aryl is any one selected from the following structural formulas: 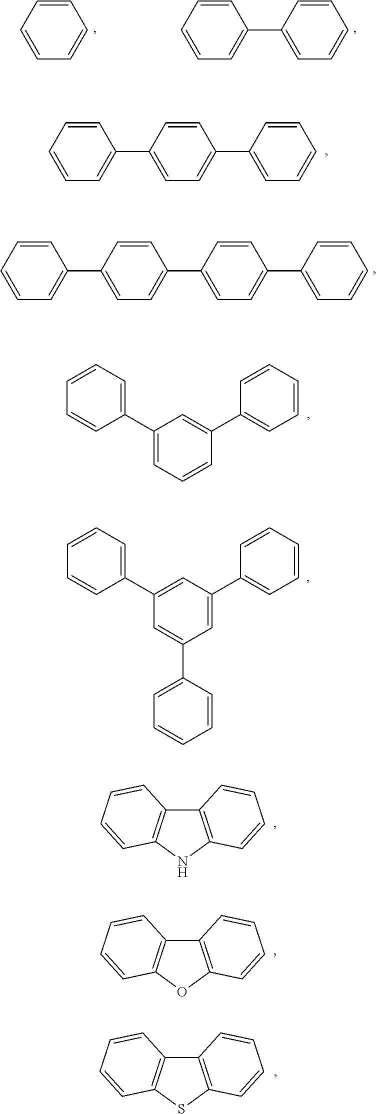
wherein n and m are integers from 1 to 10 and x and y are mole fractions (%) of polymer ionomers in the repeating unit, satisfying x>0, y>0 and x+y=100.

2. A method for preparing a poly (alkyl-aryl piperidinium) polymer ionomer, comprising:
(I) a step of forming a solution by dissolving a diphenylalkane, 1-methyl-4-piperidone and compounds represented by the following structural formulas as monomers in an organic solvent: 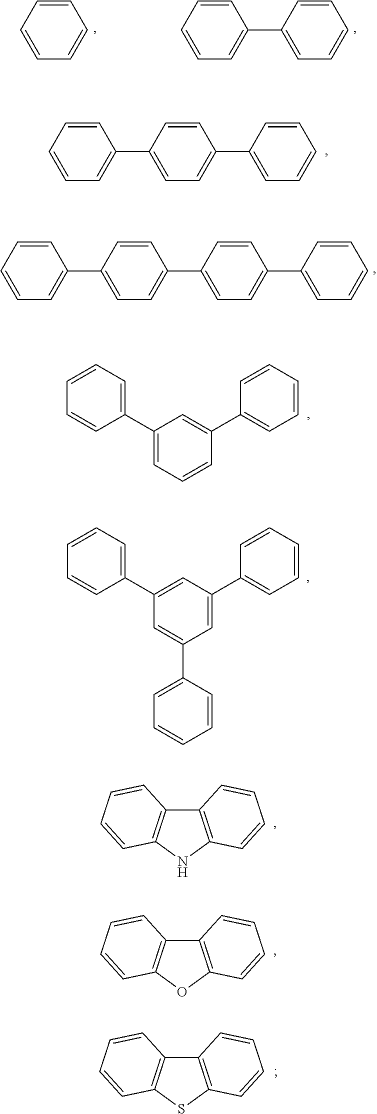
(II) a step of obtaining a viscous solution by slowly adding a strong acid catalyst to the solution and conducting stirring and reaction;
(III) a step of obtaining a polymer in the solid phase by precipitating, washing, and drying the viscous solution;
(IV) a step of forming a quaternary piperidinium salt by adding K₂CO₃ and an excess halomethane to a polymer solution obtained by dissolving the polymer in solid phase in an organic solvent and conducting a reaction; and
(V) a step of precipitating, washing, and drying the polymer solution.

3. The method for preparing a poly (alkyl-co-aryl piperidinium) polymer ionomer according to claim 2, wherein the organic solvent in step (I) is one or more selected from a group consisting of dichloromethane, chloroform, dichloroethane, dibromomethane and tetrachloroethane.

4. The method for preparing a poly (alkyl-co-aryl piperidinium) polymer ionomer according to claim 2, wherein the strong acid catalyst in step (II) is trifluoroacetic acid, trifluoromethanesulfonic acid, pentafluoroethanesulfonic acid, heptafluoro-1-propanesulfonic acid, perfluoropropionic acid, heptafluorobutyric acid or a mixture thereof.

5. The method for preparing a poly (alkyl-co-aryl piperidinium) polymer ionomer according to claim 2, wherein the organic solvent in step (IV) is N-methylpyrrolidone, dimethylacetamide, dimethyl sulfoxide, or dimethylformamide.

6. The method for preparing a poly (alkyl-co-aryl piperidinium) polymer ionomer according to claim 2, wherein the halomethane in step (IV) is fluoromethane, chloromethane, bromomethane or iodomethane

7. An anion exchange membrane comprising the poly (alkyl-co-aryl piperidinium) polymer ionomer according to claim 1.

8. An anion exchange composite membrane comprising:
a porous polymer support; and
the anion exchange membrane according to claim 7, which is impregnated in the porous polymer support.

9. A method for preparing an anion exchange membrane, comprising:
(a) a step of forming a polymer solution by dissolving the poly (alkyl-aryl piperidinium) polymer ionomer according to claim 1 in an organic solvent;
(b) a step of obtaining a membrane by casting the polymer solution on a glass plate and drying the same; and
(c) a step of treating the membrane with 1 M NaHCO₃ or 1 M NaOH, washing the same several times with ultrapure water, and then drying the same.

10. The method for preparing an anion exchange membrane according to claim 9, wherein the organic solvent is N-methylpyrrolidone, dimethylacetamide, dimethyl sulfoxide, or dimethylformamide.

11. The method for preparing an anion exchange membrane according to claim 9, wherein the concentration of the polymer solution is 2-30 wt %.

12. The method for preparing an anion exchange membrane according to claim 9, wherein the drying in step (b) is performed by slowly removing the organic solvent in an oven at 80-90° C. for 24 hours and then completely removing the organic solvent by heating for 12 hours in a vacuum oven at 120-150° C.

13. A method for preparing an anion exchange composite membrane, comprising:
(i) a step of preparing a porous polymer support;
(ii) a step of obtaining an ionomer solution by adding a cosolvent to a polymer solution prepared by dissolving the poly (alkyl-co-aryl piperidinium) polymer ionomer according to claim 1 in an organic solvent; and
(iii) a step of casting the ionomer solution on the porous polymer support and then impregnating and drying the same.

14. The method for preparing an anion exchange composite membrane according to claim 13, wherein the cosolvent in step (ii) is methanol, ethanol, or isopropyl alcohol.

15. The method for preparing an anion exchange composite membrane according to claim 13, wherein the amount of the cosolvent added in step (ii) is 2-25 wt % based on the polymer solution.

16. A binder for an alkaline fuel cell, comprising the poly (alkyl-co-aryl piperidinium) polymer ionomer according to claim 1.

17. A membrane electrode assembly for an alkaline fuel cell, comprising the anion exchange membrane according to claim 7.

18. An alkaline fuel cell comprising the anion exchange membrane according to claim 7.

19. A water electrolysis device comprising the anion exchange membrane according to claim 7.

20. A membrane electrode assembly for an alkaline fuel cell, comprising the anion exchange composite membrane according to claim 8.

21. An alkaline fuel cell comprising the anion exchange composite membrane according to claim 8.

22. A water electrolysis device comprising the anion exchange composite membrane according to claim 8.
